(19) United States
(12) Patent Application Publication
(10) Pub. No.: US 2026/0032201 A1
(43) Pub. Date: Jan. 29, 2026

(54) PRINTER CONFIGURING TARGET PARAMETER SET AS ACTIVE PARAMETER SET AVAILABLE FOR PROCESSING

(71) Applicant: BROTHER KOGYO KABUSHIKI KAISHA, Nagoya (JP)

(72) Inventor: Tomoya KANEKO, Nagoya (JP)

(73) Assignee: BROTHER KOGYO KABUSHIKI KAISHA, Nagoya (JP)

(21) Appl. No.: 19/264,462

(22) Filed: Jul. 9, 2025

(30) Foreign Application Priority Data
Jul. 24, 2024 (JP) 2024-118623
Oct. 31, 2024 (JP) 2024-191490

(51) Int. Cl. H04N 1/00; H04N 1/44

(52) U.S. Cl. CPC H04N 1/00395; H04N 1/00962; H04N 1/4413; H04N 2201/0094

(57) ABSTRACT

A printer includes a communication interface, a memory, and a controller including one or more processors. The controller perform an activation process under an activation start condition including a requirement that a target parameter set including a plurality of target parameters is stored in the memory as an inactive parameter set not available for processing in the printer, a requirement that an activation command is received from an external device via the communication interface, and a requirement that the activation command is a command to activate the target parameter set. The activation process includes configuring the target parameter set as an active parameter set available for processing in the printer. The controller performs and a controlling process under a controlling condition including a requirement that the activation process is completed. The controlling process is based on the target parameter set.

### REFERENCE TO RELATED APPLICATIONS

This application claims priorities from Japanese Patent Application No. 2024-118623 filed on Jul. 24, 2024, and Japanese Patent Application No. 2024-191490 filed on Oct. 31, 2024. The entire contents of the priority applications are incorporated herein by reference.

### BACKGROUND ART

A known printer can accept parameters inputted by a user and perform control based on those parameters. For example, one printer has an external function that combines various processes to execute a process sequence by receiving and processing data for a plurality of instructions in sequence. The printer is configured to: accept input for parameters to be used with this external function, including a name, a URL, and an execution condition; receive instruction data from a server based on parameters set through this input; and perform processes in accordance with this instruction data.

### SUMMARY

With the above technology, a plurality of parameters used for the external function is inputted and configured in the printer in advance. This technology leaves room for improvement because the operations for configuring the parameters are time-consuming for the user.

In view of the foregoing, it is an object of the present disclosure to provide a printer to improve a process for configuring the parameters.

In order to attain the above and other objects, the present disclosure provides a printer. The printer includes a communication interface, a memory, and a controller including one or more processors. The controller is configured to perform: an activation process under an activation start condition including: a requirement that a target parameter set including a plurality of target parameters is stored in the memory as an inactive parameter set not available for processing in the printer; a requirement that an activation command is received from an external device via the communication interface; and a requirement that the activation command is a command to activate the target parameter set, the activation process including: configuring the target parameter set as an active parameter set available for processing in the printer; and a controlling process under a controlling condition including a requirement that the activation process is completed, the controlling process being based on the target parameter set.

In the above structure, the target parameter set stored in the memory is configured as an active parameter set available for processing the printer, thereby reducing the time and effort for operations of a user.

In order to attain the above and other object, the present disclosure provides a printer. The printer includes a communication interface, a memory, and a controller including one or more processors. The controller is configured to perform: an accessing process under an access condition including: a requirement that a first parameter set is stored in the memory as an active parameter set available for processing in the printer; and a requirement that the first parameter set includes a first address parameter indicating a first address, the accessing process including: accessing a first destination specified by the first address via the communication interface; and a frequency reducing process under a reducing condition including a requirement that the accessing process is completed, the frequency reducing process including: reducing a warning frequency, the warning frequency being a frequency of execution of a first warning process based on a consumption level regarding a consumable.

In the above structure, the first parameter set stored in the memory as an active parameter set for processing in the printer can be used for reducing the reducing a warning frequency without time and effort for operations of a user.

In order to attain the above and still other object, the present disclosure provides a printer. The printer includes a communication interface, a user interface, a memory, and a controller including one or more processors. The controller is configured to perform: an accessing process under an access condition including: a requirement that a target parameter set is stored in the memory as an active parameter set available for processing in the printer; and a requirement that the target parameter set includes an address parameter indicating an address, the accessing process including: accessing a first destination specified by the address via the communication interface; and either a first process or a second process. The first process includes: a first display process under a condition including: a requirement that the target parameter set is stored in the memory as the active parameter set available for processing in the printer; and a requirement that the accessing process is not started, the first display process including: displaying a standby screen in which a display object is placed in a first mode on the user interface, the display object being for issuing an instruction to access the first destination specified by the address; and a first switching process under a first switching condition including a requirement that the accessing process is completed, the first switching process including: switching the display object from the first mode to a second mode different from the first mode. The second process includes: a second display process under a condition including: a requirement that the target parameter set is stored in the memory as the active parameter set available for processing in the printer; and a requirement that the accessing process is not started, the second display process including: displaying the standby screen in which the display object is placed in an enabled state where an access instruction to access the first destination specified by the address can be issued when the display object is operated; and a second switching process under a second switching condition including a requirement that the accessing process is completed, the second switching process including: switching the display object from the enabled state to one of: a first disabled state where the display object cannot be operated; or a second disabled state where the access instruction cannot be issued based on an operation of the display object.

In the above structure, the standby screen is switched after the accessing process is completed. Thus, the standby screen can be transitioned to the state that reflects the result of the accessing process.

### BRIEF DESCRIPTION OF DRAWINGS

FIG. 1 is a block diagram illustrating an electric configuration of a system including a multifunction peripheral (MFP).

FIG. 2 is a sequence diagram illustrating a procedure to activate a parameter set.

FIG. 3A is an illustration showing a standby screen.

FIG. 3B is an illustration showing a selection screen.

FIG. 4A is an illustration showing an example of an external function parameter set.

FIG. 4B is an illustration showing a registration screen.

FIG. 5A is an illustration showing an example of an eco mode parameter set.

FIG. 5B is an illustration showing settings screens.

FIG. 6 is a flowchart illustrating a confirmation process.

FIG. 7 is an illustration showing an example of activation instruction data.

FIG. 8 is a flowchart illustrating a parameter activation process.

FIG. 9 is a flowchart illustrating a function activation process.

FIG. 10 is an illustration showing a structure of an external function parameter information.

FIG. 11 is a block diagram illustrating an electric configuration of a system including an MFP.

FIGS. 12A and 12B are illustrations showing examples of information stored in servers.

FIG. 13 is a sequence chart illustrating a procedure to activate a parameter set.

FIG. 14A is an illustration showing an example of an external function parameter set.

FIG. 14B is an illustration showing a registration screen.

FIG. 15 is a flowchart illustrating a startup process.

FIGS. 16A-16C are illustrations showing transitions of a home screen.

FIG. 17 is a sequence chart illustrating an initial setup process.

FIG. 18 is an illustration showing a warning non-notification command.

FIG. 19 is an illustration showing a parameter setting command.

FIG. 20 is an illustration showing instruction data.

FIG. 21 is a flowchart illustrating a downloading and configuration process.

### DESCRIPTION

Below, embodiments of the printer according to the present disclosure will be described while referring to the accompanying drawings. This specification describes a multifunction peripheral (hereinafter abbreviated as “MFP”) that possesses various functions, including printing and communication functions.

### First Embodiment

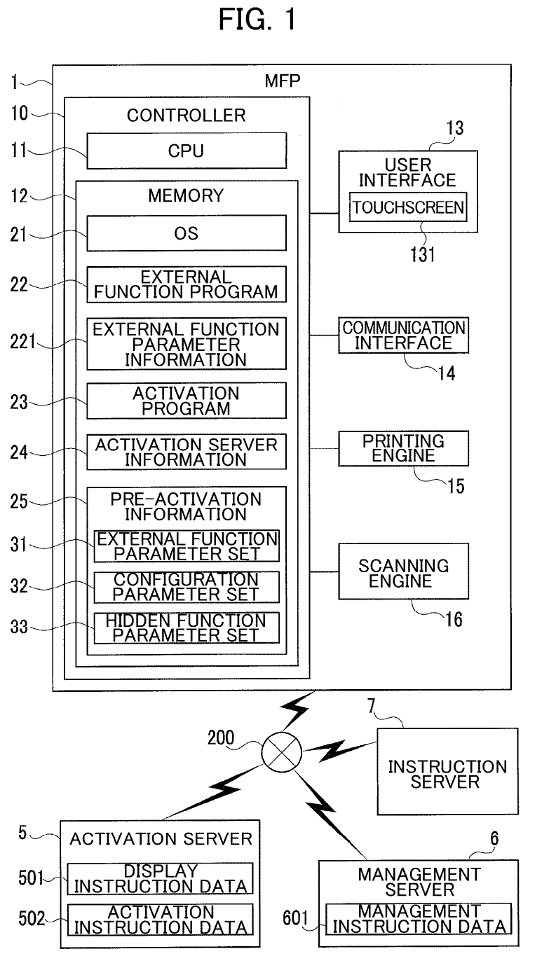

FIG. 1 shows an example of an MFP 1 according to the present embodiment. The MFP 1 includes a controller 10 that includes a CPU 11 and a memory 12. The MFP 1 also includes a user interface (hereinafter also called “user IF”), a communication interface (hereinafter also called “communication IF”) 14, a printing engine 15, and a scanning engine 16, all of which are electrically connected to the controller 10. Note that the controller 10 in FIG. 1 is a general concept that covers all hardware and software used for controlling the MFP 1 and is not limited to representing a single piece of hardware actually present in the MFP 1. The MFP 1 is an example of the printer.

The CPU 11 of the MFP 1 executes various processes according to programs read from the memory 12 or based on user operations. The memory 12 is used as a work area when the CPU 11 executes various processes. As shown in FIG. 1, the memory 12 stores various programs including an operating system (hereinafter “OS”) 21, an external function program 22, and an activation program 23, and various data including activation server information 24 and pre-activation information 25.

The external function program 22 controls the MFP 1 to implement an external function. Through the external function, the MFP 1 accesses an external server, receives instruction data from the external server, and executes processes in accordance with the instruction data. External function parameter information 221 is information for using functions implemented by the external function program 22. Multiple parameter sets can be registered in the external function parameter information 221. A unique registration ID is associated with each parameter set. Each parameter set includes a plurality of parameters. No parameter sets may be registered in the external function parameter information 221 when the MFP 1 is shipped from the factory. The external function is an example of the specific function.

The external function program 22 not only controls the MFP 1 to implement external functions in accordance with the external function parameter information 221 but can also control the MFP 1 to implement an external function in accordance with the activation server information 24. The activation server information 24 enables the MFP 1 to access an activation server 5 described later based on the external function program 22.

The activation program 23 controls the MFP 1 to perform a process for setting an inactive parameter set contained in the pre-activation information 25 as an active parameter set. An inactive parameter set refers to a set of parameters that is stored in the memory 12 but is not available for controlling the MFP 1. In other words, an active parameter set refers to set of parameters that is in a deactivated state. An activated parameter set is a set of parameters that is available for controlling the MFP 1. The activated parameter set may be a parameter set stored in such a manner that validity of the parameter set can be identified. A parameter set that is available for controlling the MFP 1 may also be referred to as an “active parameter set” or a “parameter set stored in an active state (or parameter set stored in an enabled state).” The active parameter set may indicate a parameter set available for processing in the MFP 1.

The pre-activation information 25 includes at least one of an external function parameter set 31, a configuration parameter set 32, and a hidden function parameter set 33. The external function parameter set 31, configuration parameter set 32, and hidden function parameter set 33 each contain a plurality of parameters. The parameter sets contained in the pre-activation information 25 are inactive parameter sets.

The activation server information 24 and pre-activation information 25 are stored on the MFP 1 before the MFP 1 is delivered to the user. For example, the activation server information 24 and pre-activation information 25 may be stored in the memory 12 during the process of manufacturing the MFP 1 or may be stored in the memory 12 after the MFP 1 is manufactured and before the MFP 1 is shipped to the user. The activation server information 24 and pre-activation information 25 can also be stored in the memory 12 when upgrading the firmware version of the MFP 1. The activation server information 24 and pre-activation information 25 may also be stored in the memory 12 by service personnel performing maintenance on the MFP 1 after the MFP 1 has been shipped.

The activation server information 24 enables the MFP 1 to access an activation server 5 described later. By using the activation server information 24, the MFP 1 can access the activation server 5 through a function of the external function program 22 and perform a process for setting an inactive parameter set to an active parameter set.

Examples of the memory 12 may include ROM, RAM, or a hard disk drive, built into the MFP 1, or may be a storage medium that is readable and writable by the CPU 11. A USB memory connected to the MFP 1, an external memory such as a hard disk drive, and a memory or hard disk drive in a device connected to the MFP 1 via the communication interface 14 are all examples of the memory 12. A buffer in the CPU 11 is also an example of the memory 12.

A computer-readable storage medium is a non-transitory medium. In addition to the above examples, non-transitory media include CD-ROM and DVD-ROM. A non-transitory medium is also a tangible medium. On the other hand, electric signals that convey programs downloaded from a server on the Internet are a computer-readable signal medium, which is one type of computer-readable medium but is not a non-transitory computer-readable storage medium.

The user interface 13 includes a touchscreen 131, for example. The touchscreen 131 is hardware that displays screens for reporting information to the user, and hardware that receives user operations. The touchscreen 131 includes a liquid crystal display (LCD) panel, for example. As an alternative, the user interface 13 may include an LCD panel that has a function for displaying screens but not a function for receiving user operations, and hardware buttons that function to receive user operations. The user interface 13 and the touchscreen 131 are examples of electronic devices or examples of electronic components.

The MFP 1 also has an embedded web server (EWS) function as an example of the user interface. When the EWS is accessed from a browser running on a personal computer, or smartphone, the MFP 1 transmits web page data to the browser for displaying a screen. When the MFP 1 receives information from the browser specifying an operation performed in the displayed web page based on the transmitted web page data, the MFP 1 can execute a process in accordance with the operation.

The communication interface 14 includes hardware capable of connecting to a network 200 and external devices. The communication interface 14 also includes functions supporting such communication standards as Wi-Fi (U.S. trademark of Wi-Fi Alliance CORPORATION), Ethernet, and Universal Serial Bus (USB). The MFP 1 may also include a plurality of communication interfaces 14 supporting a plurality of communication standards. The communication interface 14 may be referred to as a network interface.

The printing engine 15 includes configurations for printing images on sheets or other print media based on image data. The method of image formation used by the printing engine 15 may be the electrophotographic method or the inkjet method, for example. The printing engine 15 is an example of the electronic device or an example of the electronic component.

The scanning engine 16 includes configurations for scanning a document placed on a flat bed or a document set in a document feeder and conveyed to a reading position, and for generating scan data as the scanning results.

As shown in FIG. 1, the MFP 1 can connect to the network 200 via the communication interface 14 and can access servers via the network 200, including an activation server 5, a management server 6, and an instruction server 7. When the MFP 1 accesses one of the activation server 5, management server 6, and instruction server 7 using a predetermined URL, the respective server can transmit instruction data stored in association with the URL to the MFP 1 instructing the MFP 1 to perform a prescribed process. The activation server 5, management server 6, and instruction server 7 may each be capable of transmitting multiple sets of instruction data. The activation server 5, management server 6, and instruction server 7 may each store the instruction data to be transmitted. The various instruction data transmitted from the activation server 5, management server 6, and instruction server 7 are information that can be analyzed by the external function program 22 on the MFP 1. An example of instruction data is an xml file prepared by a designer of a system including all or part of the system including the MFP 1 and the servers 5-7, for example.

A designer of a system that includes the activation server 5 may be a vendor of the MFP 1, or a designer or service person for the manufacturer or a retailer of the MFP 1, for example. A designer of a system that includes the management server 6 may be a system administrator who manages a business system including the MFP 1 or an administrator of a vendor for the system that provides the management server 6, for example. A designer of a system that includes the instruction server 7 may be a system administrator that manages a business system including the MFP 1, for example. Naturally, these are merely examples, and the designers of these systems are not limited to the above examples.

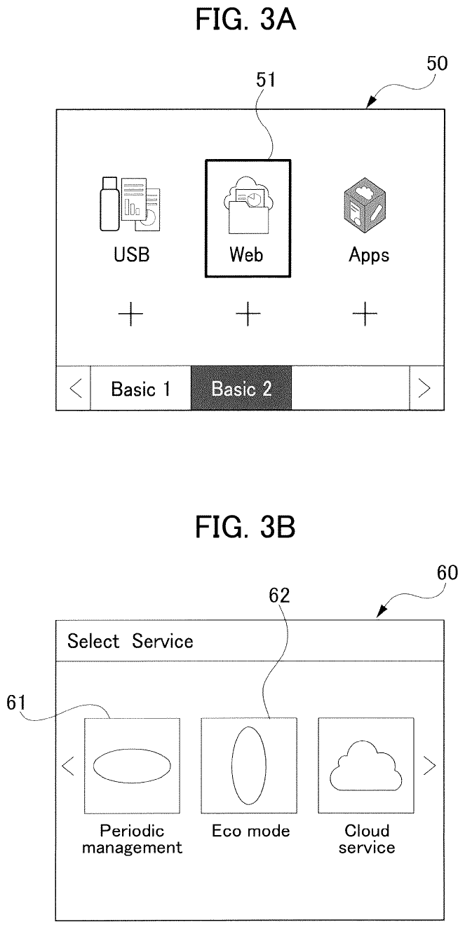

As shown in the example of FIG. 1, the activation server 5 can store and transmit display instruction data 501 and activation instruction data 502. The display instruction data 501 and activation instruction data 502 are information that the external function program 22 of the MFP 1 can analyze and execute, such as an xml file. The display instruction data 501 is instruction data for instructing the MFP 1 to display a selection screen shown in FIG. 3B. The activation instruction data 502 is instruction data for instructing the MFP 1 to activate a stored parameter set. The management server 6 can transmit management instruction data 601. The management instruction data 601 is instruction data containing instructions for managing the MFP 1. An example of the instruction for managing the MFP 1 is an instruction requesting the MFP 1 to send information to be managed by the management server 6, such as the status of the MFP 1, to the management server 6. Information to be managed by the management server 6 will also be referred to as “management information.” “Instruction data instructing XXX” may also be worded as “instruction data for instructing XXX,” “instruction data including XXX instructions,” “instruction data including instructions for XXX.”

The activation server 5, management server 6, and instruction server 7 may also be capable of transmitting instruction data other than the instruction data shown in FIG. 1. For example, the servers 5 and 7 may be capable of transmitting instruction data for using various cloud services. Further, the servers 5-7 are not limited to being independent devices but may be combined into an integrated unit, or each may be configured of a combination of multiple devices.

The MFP 1 may be capable of connecting not only to the servers 5-7 prepared by the designers of the respective systems but also to a function server prepared by the system administrator of the company that installed the MFP 1. For example, a system administrator of the company that installed the MFP 1 can prepare instruction data for use by that company and store this data on a prepared function server. By accessing this function server, an MFP 1 of that company can obtain instruction data prepared by the system administrator of the company and can execute operations according to the external function program 22 based on the obtained instruction data. The function to user the function server prepared by the administrator of the company is an example of the specific function.

The processes executed by the MFP 1 will be described. In the following description, actions such as “determine,” “extract,” “select,” “calculate,” “set,” “identify,” “obtain,” “receive,” and “control,” “set,” represent processes performed by the CPU 11. Processes performed by the CPU 11 include processes that control hardware through application programming interfaces (APIs) of the OS. In the description, an operation of each program is described without referring to the OS. For example, expressions, such as “program B controls hardware C” may indicate “program B controls hardware C by using an API included in the OS”. Further, processes performed by the CPU 11 according to instructions described in a program may be described in abbreviated terms, such as “the CPU 11 executes” or “the program executes.”

In the description, the terms “notice”, “notification”, “report”, “reply”, “response”, and “answer” are used not only to refer to communication directed to a person, but also refer to communication between devices or information transmission or reception between devices. A configuration included in a device includes software.

Note that the term “acquire” in this specification is used as a concept that does not necessarily require a request. In other words, a process by which the CPU 11 receives data without requesting that data is included in the concept of “the CPU 11 acquires data.” This holds true for the term “obtain”. The term “data” described herein is expressed as bit strings that can be read by a computer. Data of different formats are treated as the same data when the content of the data is essentially the same. The same holds true for “information” in this specification. An “instruction” or a “request” is processed by outputting information indicating the “instruction,” or the “request.” The term “instruction” or “request” may also be used to describe information indicating an “instruction” or a “request.”

Further, a process performed by the CPU 11 to determine whether information A indicates circumstance B may be described conceptually as “determining whether circumstance B based on information A.” A process in which the CPU 11 determines whether information A indicates circumstance B or circumstance C may be described conceptually as “determining whether circumstance B or circumstance C based on information A.”

In this specification, a setting item may simply be referred to as a “setting.” Setting values may be referred to simply as “settings.” Setting values may also be described as “parameters.” The term “parameter” refers to a variable element that receives input or to the value assigned to such an element, depending on the context. Further, the process of storing a setting value in memory may be referred to simply as “setting.” An operation for setting a setting value or the act of inputting a setting value may also simply be referred to as “setting.”

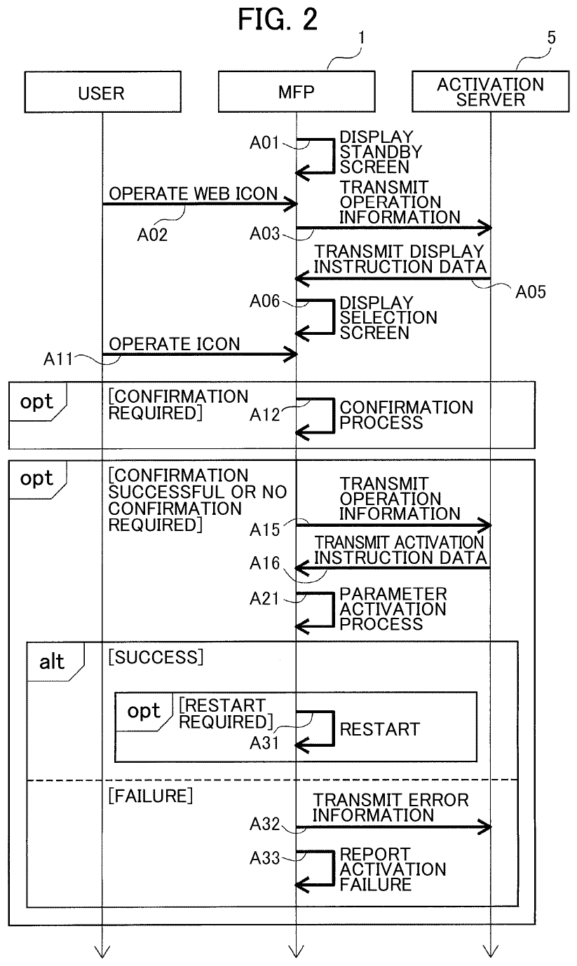

As described above, the MFP 1 of the present embodiment stores the pre-activation information 25 including inactive parameter sets in the memory 12. Here, steps for activating a parameter set in the pre-activation information 25 will be described with reference to the sequence diagram in FIG. 2.

When started up or while in a standby state, in A01 the MFP 1 displays a standby screen on the user interface 13. The standby screen may be displayed, as a home screen, immediately after the MFP 1 is powered on. The standby screen may be a screen of web page based on data described in HyperText Markup Language (HTML). The standby screen includes multiple icons through which the MFP 1 can accept user operations. As shown in the example of FIG. 3A, the MFP 1 can display a standby screen 50 that includes a Web icon 51. The standby screen 50 may be referred to as a Web screen 50. The standby screen includes multiple screens that are switchable, and FIG. 3A shows a state where one of the multiple screens included in the standby screen is displayed.

In this example, in A02 the user operates the Web icon 51. When the Web icon 51 is operated, in A03 the MFP 1 transmits operation information indicating that the Web icon 51 has been operated to the activation server 5 based on the activation server information 24 (described in detail below) stored in the memory 12. In response to receiving this operation information indicating that the Web icon 51 has been operated, in A05 the activation server 5 transmits the display instruction data 501 to the MFP 1.

After receiving the display instruction data 501 from the activation server 5 via the communication interface 14, the MFP 1 analyzes the display instruction data 501 in accordance with the external function program 22 and in A06 displays a selection screen 60 based on the display instruction data 501, as shown in the example of FIG. 3B. The selection screen 60 includes activation icons 61 and 62. The activation icons 61 and 62 function to accept activation instructions.

The activation server information 24 includes a URL that the MFP 1 accesses to request transmission of the display instruction data 501. Thus, the MFP 1 can access the activation server 5 in accordance with the activation server information 24. The display instruction data 501 instruction data indicating an instruction to display the selection screen 60. An operation performed on the Web icon 51 in the standby screen 50 is an operation for issuing an instruction to send operation information to the activation server 5 based on the activation server information 24. When the MFP 1 cannot connect to the activation server 5 and, hence, cannot transmit operation information in A03, for example, the MFP 1 may display an error message and subsequently return the display to the standby screen 50. The activation server information 24 is an example of access destination information (or address information). The display instruction data 501 is an example of the first instruction data. The operation of the Web icon 51 is an example of the specific operation. The URL included in the activation server information 24 is an example of the destination or the address. The activation server information 24 is an example of the destination information (address information) indicating the destination.

The activation server information 24 is stored on the MFP 1 in advance and serves as access destination information for receiving the display instruction data 501 as the first instruction data. When the Web icon 51 is operated, the MFP 1 can receive the display instruction data 501 using the activation server information 24. In this way, the MFP 1 can display the selection screen 60 and can accept a user selection of the activation icons 61 and 62, thereby simplifying the user's operations for activating a parameter set. The MFP 1 may also analyze instruction data for activation, such as the display instruction data 501 using the activation program 23, and perform a process based on the analysis results using the activation program 23.

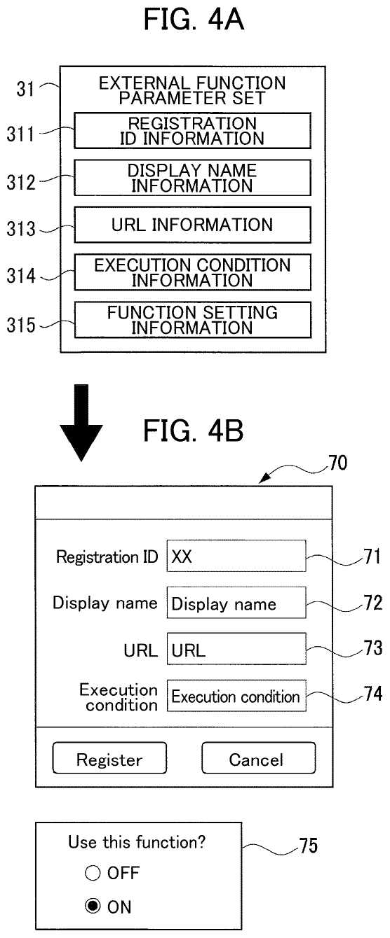

The activation icon 61 shown in FIG. 3B is an example of an icon through which the MFP 1 accepts an instruction to activate the external function parameter set 31, which is included in the pre-activation information 25 stored in the memory 12. As shown in the example of FIG. 4A, the external function parameter set 31 includes information on various parameters that can be registered on the MFP 1 in the external function parameter information 221 of the external function program 22. The external function parameter set 31 will be described later in greater detail.

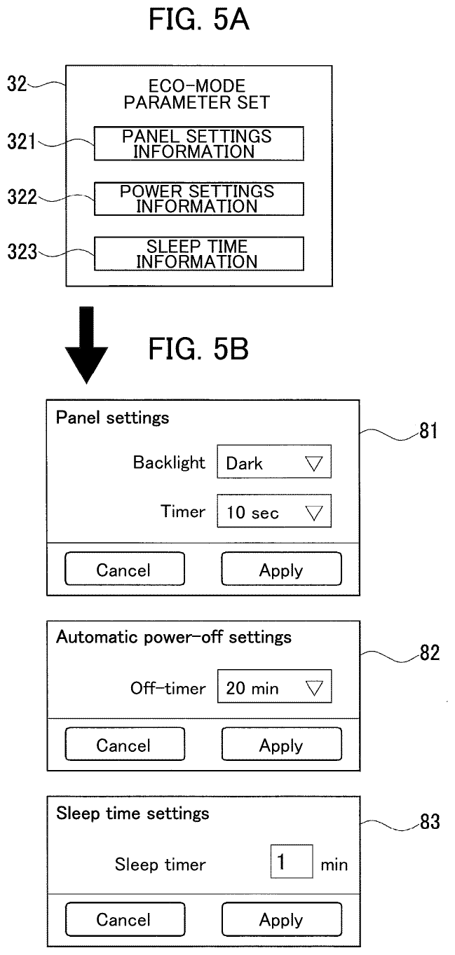

The activation icon 62 shown in FIG. 3B is an example of an icon through which the MFP 1 accepts an instruction to activate the configuration parameter set 32, which is included in the pre-activation information 25 stored in the memory 12. As shown in the example of FIG. 5A, the configuration parameter set 32 includes information on various parameters that can be configured in the MFP 1. The configuration parameter set 32 will be described later in greater detail.

The pre-activation information 25 on the MFP 1 may include a plurality of types of external function parameter sets and a plurality of types of configuration parameter sets. For example, a type of configuration parameter sets is a type of eco mode parameter sets such as a parameter set to reduce power consumption. In addition to the eco mode parameter set, the MFP 1 may store other configuration parameter sets such as a parameter set for enhancing security. In a case where the pre-activation information 25 includes a plurality of types of external function parameter sets and a plurality of types of configuration parameter sets, the MFP 1 may display pluralities of activation icons 61 and activation icons 62 to correspond with each parameter set and may be capable of accepting a user selection through these activation icons 61 and 62. On the other hand, in a case the pre-activation information 25 does not include the configuration parameter set 32 for example, the icon 62 corresponding to the configuration parameter set 32 may be omitted from the selection screen 60.

When the activation server 5 can communicate with a plurality of MFPs 1, each MFP may contain parameter sets different from other MFPs in the pre-activation information 25. In this case, in A03 the MFP 1 may transmit, to the activation server 5, information that indicates the parameter sets contained in the pre-activation information 25 stored in the memory 12 of the MFP 1. Based on the information received from the MFP 1, the activation server 5 returns display instruction data 501 for displaying a selection screen on the MFP 1. This selection screen will include an activation icon for each parameter set. The MFP 1 may then display the selection screen in accordance with the display instruction data 501 received from the activation server 5 and, when the user selects an activation icon in the displayed selection screen, may activate the corresponding parameter set.

Further, MFPs that contain different parameter sets in their pre-activation information 25 may store different unique URLs as their activation server information 24. In this case, the activation server 5 may transmit display instruction data 501 to the MFP for displaying a selection screen including activation icons associated with the URL that the MFP has used for accessing the activation server 5, i.e., an activation icon corresponding to each parameter set included in the pre-activation information 25 of the MFP that has accessed the activation server 5 using this URL. The activation server 5 may also determine what activation icons are to be included in the selection screen displayed on the MFP.

Further, the URL stored as the activation server information 24 on MFPs that do not store any pre-activation information 25 may differ from the URL stored as the activation server information 24 on MFPs that do store pre-activation information 25. In this case, a selection screen may be associated with each URL used to access the activation server 5. Thus, the activation server 5 can transmit display instruction data 501 for displaying a selection screen with no activation icons to the former MFPs (i.e., the MFPs that do not store any pre-activation information 25). An MFP that does not store any pre-activation information 25 may also transmit information to the activation server 5 indicating that the MFP does not possess pre-activation information 25. Even in such a case, the activation server 5 may send the display instruction data 501 to the MFP for displaying a selection screen containing no activation icons on the MFP.

In A11 the user performs an operation in the selection screen 60 currently being displayed to select an icon from among the plurality of options. When the MFP 1 determines that confirmation or authentication is required based on the user-selected icon (opt: confirmation required), in A12 the MFP 1 executes a confirmation process. For example, when an operation on the activation icon 61 has been received, the MFP 1 determines that confirmation is required when the function that can be executed by activating the selected external function parameter set 31 is one that requires user confirmation or authentication before execution. The external function parameter set 31 may include information specifying whether the function requires user confirmation or authentication prior to use. The activation icon that indicates that the user confirmation or authentication is necessary is an example of the specific option.

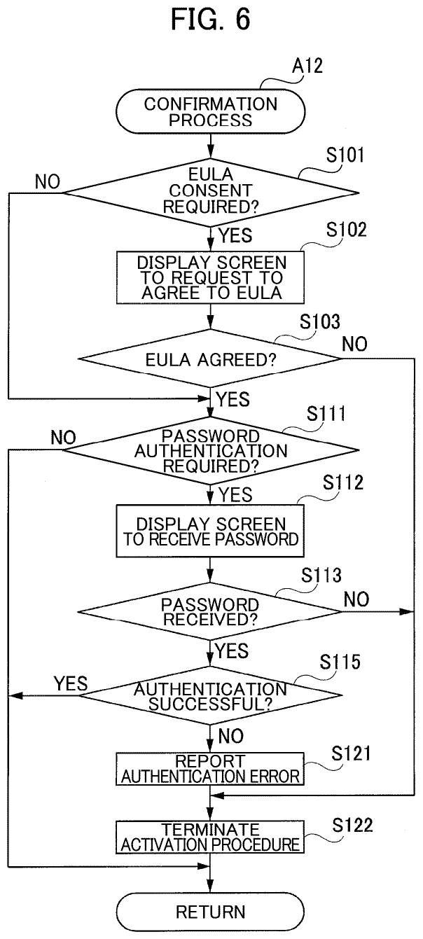

Steps in the confirmation process will be described with reference to the flowchart in FIG. 6. The CPU 11 of the MFP 1 executes this confirmation process based on the activation program 23.

In S101 of FIG. 6, the CPU 11 determines whether the parameter set selected to be activated is for a function requiring the user to agree to an end-user license agreement (EULA). When the CPU 11 determines that EULA consent is required (S101: YES), in S102 the CPU 11 displays a screen requesting the user to agree to the EULA and in S103 accepts user input.

However, when the CPU 11 determines that EULA consent is not necessary (S101: NO) or when the CPU 11 receives input agreeing to the EULA (S103: YES), in S111 the CPU 11 determines whether password authentication is required. When the CPU 11 determines that password authentication is required (S111: YES), in S112 the CPU 11 displays a screen for accepting password input and in S113 accepts user input. The password is an example of the authentication information.

Once password input has been received (S113: YES), in S115 the CPU 11 determines whether the entered password has been successfully authenticated. The CPU 11 makes the determination in S115 based on user information stored in the memory 12 in advance, for example. Alternatively, the CPU 11 may transmit the inputted password to an authentication server that can be accessed from the MFP 1 and receives the authentication result from the authentication server. On the other hand, when the CPU 11 determines that password authentication is not necessary (S111: NO) or determines that authentication has been successful (S115: YES), the CPU 11 ends the confirmation process and returns to the process in FIG. 2. The process of S11 is an example of the authentication process.

However, when the CPU 11 determines that authentication has failed (S115: NO), in S121 the CPU 11 displays a screen informing the user of the authentication error. The CPU 11 may also accept the reentry of a password at this time. The screen displayed in S121 is an example of the notification screen.

Following S121 or when the CPU 11 has received input indicating nonacceptance of the EULA (S103: NO) or when the password entry screen has been closed without receiving the password (S113: NO), in S122 the CPU 11 terminates the activation procedure. In this case, the CPU 11 does not resume the process in FIG. 2 but returns the display to the standby screen 50.

In other words, the MFP 1 does not perform the activation procedure in a case where the confirmation process has been unsuccessful, despite EULA consent or password authentication being required. By making activation of an external function parameter set conditional on EULA consent and successful authentication, the MFP 1 can restrict a third party from imprudently activating an inactive parameter set.

When the confirmation process of A12 is completed successfully or when the selected activation icon indicates a function that does not require confirmation or authentication (opt: confirmation successful or no confirmation required), in A15 the MFP 1 transmits operation information to the activation server 5 including information on the icon for which an operation has been received in A11. In A16 the activation server 5 transmits the next instruction data to the MFP 1 based on the operation information. In this case, the next instruction data is the activation instruction data 502. The activation instruction is an example of the second instruction data.

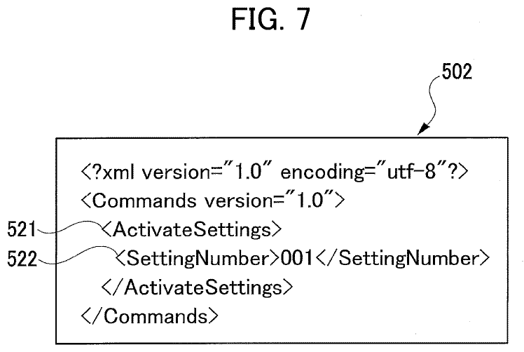

The activation instruction data 502 is an xml file that the activation program 23 of the MFP 1 can analyze. As shown in the example of FIG. 7, the activation instruction data 502 is an xml file with an instruction to execute a process. The activation instruction data 502 includes an <Activate Settings> command 521 specifying an activation instruction, and <Setting Number> information 522 designating the parameter set to be activated. The various tag names and their values are not limited to the example in FIG. 7, provided that they can be analyzed by the activation program 23 or the external function program 22. The <Activate Settings> command 521 is an example of the activation command. The activation instruction data 502 is an example of the instruction data including the activation command. The activation instruction data 502 is an example of the second instruction data.

Since a plurality of parameter sets can be registered in the pre-activation information 25, the activation instruction data 502 includes information specifying which parameter set registered in the pre-activation information 25 is to be activated. In the example of FIG. 7, the <Setting Number> information 522 included in the activation instruction data 502 specifies the parameter set to be activated. When the <Setting Number> is 001, as shown in FIG. 7, the MFP 1 activates the first parameter set among the sets registered in the pre-activation information 25, i.e., the external function parameter set 31 in this example. The pre-activation information 25 is not limited to this example but may have just one registered parameter set. Alternatively, the MFP 1 may be configured to allow only one parameter set to be registered in the pre-activation information 25. When only one parameter set is registered in the pre-activation information 25, the activation instruction data 502 may not include the <Setting Number> information 522.

The MFP 1 has a function for receiving activation instruction data 502 from the activation server 5 via the communication interface 14 and using the activation program 23 to analyze the activation instruction data 502 and to execute a process based on the activation command in the activation instruction data 502. The activation instruction data 502 may also be analyzed by the external function program 22. This function is an example of the specific function. The activation server 5 transmitting the activation instruction data 502 is an example of the external device.

Instead of executing the confirmation process prior to A15, the MFP 1 may include an entered password in the operation information and transmit this information to the activation server 5. For example, the activation server 5 may transmit instruction data to the MFP 1 containing an instruction to accept password input, and the MFP 1 may receive an inputted password and transmit the password to the activation server 5 in accordance with this instruction data. In A16 the activation server 5 may then transmit the activation instruction data 502 containing information indicating the received password to the MFP 1. In this case, the MFP 1 performs the authentication as described in S115 and proceeds with the activation process when the authentication is successful, as described in S115.

Alternatively, when the activation server 5 has the information for use in performing password authentication, the activation server 5 can execute the authentication process based on the password received together with the operation information in A15. The activation server 5 may then transmit the activation instruction data 502 to the MFP 1 when authentication is successful and may transmit information indicating an authentication failure to the MFP 1 when authentication fails.

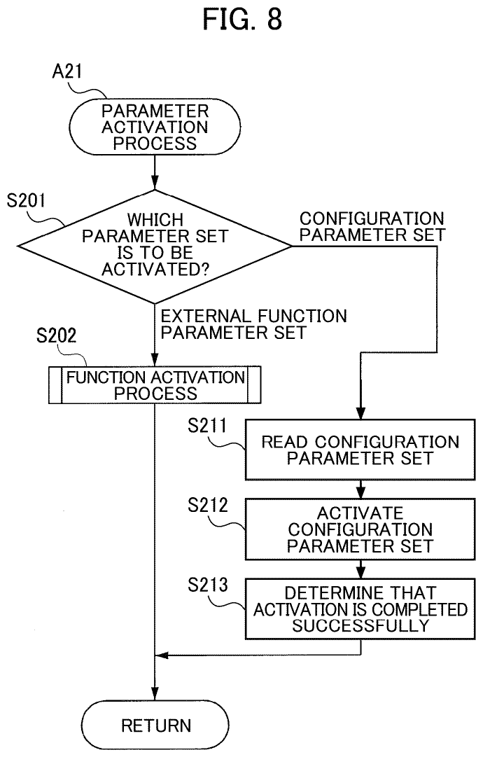

Returning to the description of the process in FIG. 2, in A21 the MFP 1 executes a parameter activation process to activate the parameter set specified in the <Setting Number> information 522 (FIG. 7) based on the activation instruction data 502 received in A16. Steps in the parameter activation process will be described here with reference to the flowchart in FIG. 8. The CPU 11 of the MFP 1 executes this parameter activation process according to the activation program 23.

In S201 the CPU 11 determines whether the parameter set to be activated is the external function parameter set 31 or the configuration parameter set 32. For example, when the CPU 11 received an operation on the activation icon 61 through the selection screen 60 shown in FIG. 3B, the parameter set to be activated is the external function parameter set 31, and the <Setting Number> information 522 specifying the external function parameter set 31 is included in the activation instruction data 502. When the CPU 11 determines that the parameter set to be activated is the external function parameter set 31 (S201: external function parameter set), in S202 the CPU 11 executes a function activation process.

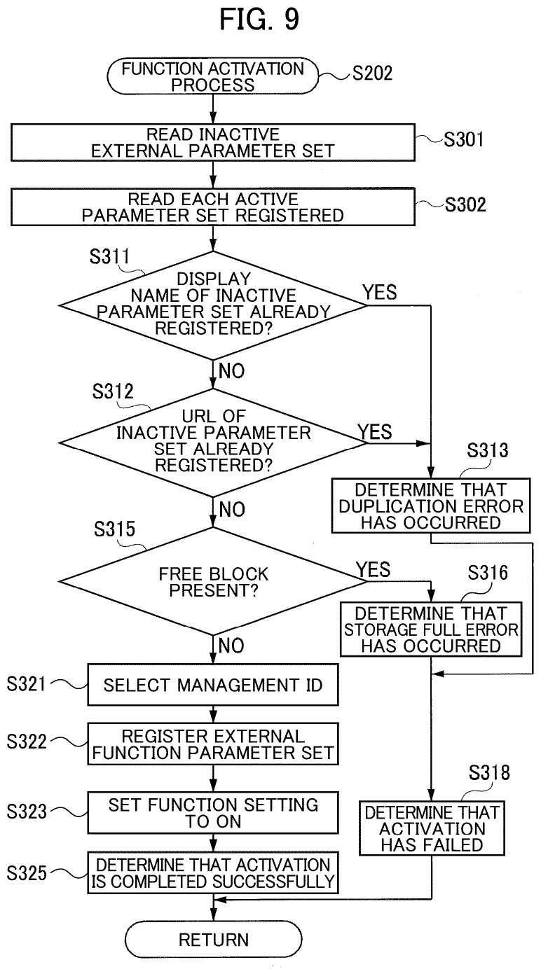

Steps in the function activation process will be described here with reference to the flowchart in FIG. 9. In S301 of FIG. 9, the CPU 11 reads the inactive parameter set specified by the <Setting Number> information 522 (the external function parameter set 31 in this case) from the memory 12. In S302 the CPU 11 also reads each active parameter set from the external function parameter information 221 in the memory 12 (see FIG. 1). Registering a parameter set in in the external function parameter information 221, as an active parameter set, may signify registering the parameter set for use by the external program 22 or registering the parameter set for the external program 22.

Activation of the external function parameter set 31 signifies that each parameter contained in that external function parameter set 31 is registered in the external function parameter information 221. That is, a parameter set based on a registration instruction that has already been received or an external function parameter set 31 that has been activated previously may be stored in the external function parameter information 221 as an active parameter set.

Here, the external function parameter information 221 will be described. Separately from registering parameter sets through the function activation process, i.e., activating external function parameter sets 31, the MFP 1 can register external function parameter sets in the external function parameter information 221 in accordance with instructions received via the user interface 13. Specifically, the MFP 1 can accept an instruction to register a parameter set in the external function parameter information 221 via a registration screen 70 displayed by the EWS in a browser, for example. Here, the browser may be a browser running on an external device, such as a personal computer and a smartphone. When a browser accesses the EWS of the MFP 1, for example, the MFP 1 returns web page data for displaying the registration screen 70 in the browser, as illustrated in FIG. 4B. The MFP 1 may also display the registration screen 70 on the touchscreen 131 in response to an operation on the touchscreen 131. The registration screen 70 is an example of the setting screen.

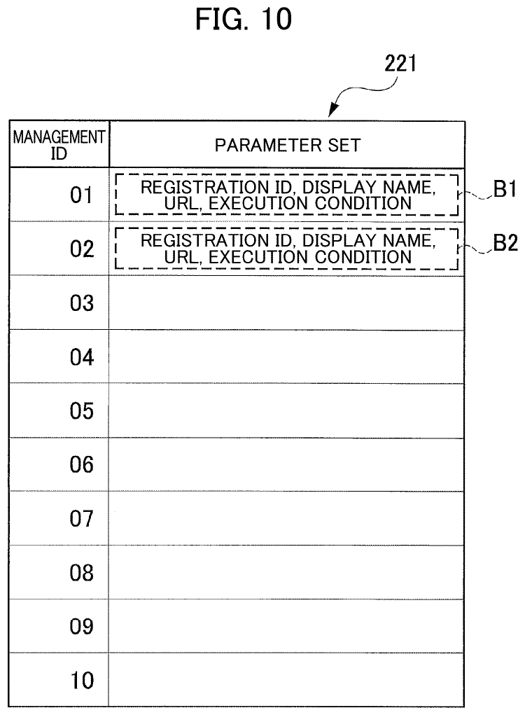

The registration screen 70 accepts input of a registration ID 71, a display name 72, a URL 73, and an execution condition 74 and includes a Register button and a Cancel button. When the MFP 1 receives a registration instruction through an operation on the Register button, the MFP 1 stores the information inputted into the registration screen 70 in the external function parameter information 221. As described above, the MFP 1 can store a plurality of parameter sets in the external function parameter information 221. As shown in the example of FIG. 10, a single parameter set containing a registration ID 71, display name 72, URL 73, and execution condition 74 is stored in one block of the external function parameter information 221 (e.g., block B1) in association with a single management ID.

The management ID is information for identifying the storage block. The registration ID 71, the display name 72, and a combination of the registration ID 71 and display name 72 are information for identifying the corresponding parameter set. The registration ID 71 may have a value the same as the management ID for identifying an individual parameter set registered in the external function parameter information 221. The MFP 1 uses the display name 72 when displaying information specifying the parameter set on the user interface 13. The URL 73 is information indicating the server to be accessed by the external function program 22. In actuality, the URL 73 is often information specifying a resource possessed by the server to be accessed but is described as information indicating the server for convenience. The execution condition 74 is information specifying a timing at which the external function program 22 is to access the server. The execution condition may be information specifying a prescribed time interval that is repeated, such as every 8 hours. Alternatively, the execution condition may be information specifying specific timings, such as a certain time on a particular day of every week, when the power is turned on, and when a prescribed operation is received from the user. The execution condition may be information specifying a schedule, according to which a process, such as an access process, is performed.

The MFP 1 can also accept an instruction to switch the screen displayed on the touchscreen 131 from the registration screen 70 to a screen for accepting an operation to specify a function setting 75. The function setting 75 indicates whether to enable use of the external function parameter information 221 with external functions. The function setting 75 has a value ON when use of the external function parameter information 221 is enabled and a value OFF when use of the external function parameter information 221 is disabled. The value of the set function setting 75 may be stored in the memory 12, as a function setting value, in association with the external function parameter set information 221.

When the function setting 75 is ON, the MFP 1 checks the execution conditions in all the parameter sets registered in the external function parameter information 221 based on the external function program 22. When an execution condition is satisfied, the MFP 1 uses the registered URL to perform the corresponding access process. That is, once the function setting becomes ON, all the parameter sets registered in the external function parameter information 221 can be used by the external function program 22, and thus each execution condition of the parameter sets in the external function parameter information is checked. That is, when one function setting is applied, that function setting determines whether all the parameter sets registered in the external function parameter information 221 can be referred by the external function program 22. However, the functional setting may be assigned for each parameter set stored in a corresponding block in the external function parameter information 221. In this case, the function setting such as the function setting information 315 may be stored in the block. In this case, the function setting indicates whether to enable use of the parameter set corresponding to that function setting. Further, in this case, the MFP 1 checks the execution condition for each parameter set in the external function parameter information 221 having the function setting indicating that use of the parameter set is enabled.

Next, the external function parameter set 31 will be described. The external function parameter set 31 is an inactive parameter set. As shown in the example of FIG. 4A, the external function parameter set 31 includes registration ID information 311, display name information 312, URL information 313, execution condition information 314, and function setting information 315. Each type of information in the external function parameter set 31 corresponds to a type of information registered in the external function parameter information 221. Specifically, the registration ID information 311 corresponds to the registration ID 71, the display name information 312 to the display name 72, the URL information 313 to the URL 73, the execution condition information 314 to the execution condition 74, and the function setting information 315 to the function setting 75.

In S311 the CPU 11 determines whether a parameter set having the same display name as that specified in the display name information 312 of the external function parameter set 31 (see FIG. 4A) is already registered in the external function parameter information 221. When the CPU 11 determines that no parameter set having the same display name is registered (S311: NO), in S312 the CPU 11 determines whether a parameter set containing the same URL as that indicated in the URL information 313 of the external function parameter set 31 is already registered in the external function parameter information 221.

When the CPU 11 determines that a parameter set having the same display name or the same URL is already registered (S311: YES or S312: YES), in S313 the CPU 11 determines that a duplication error has occurred. When a parameter set having the same display name or the same URL is stored in the external function parameter information 221, the CPU 11 does not register the duplicate parameter set in the external function parameter information 221.

Registering multiple parameter sets having the same display name in the external function parameter information 221 could confuse users. Further, when multiple parameter sets that causes multiple accesses to the server using the same URL are registered in the external function parameter information 221, processing on the server specified by that URL could become complex. When the MFP 1 receives an instruction to activate an external function parameter set 31 containing the same display name or the same URL as another parameter set already registered in the external function parameter information 221, the MFP 1 will determine an error has occurred and will not activate that parameter set, thereby reducing user confusion and complication of processing.

However, when the CPU 11 determines that neither a parameter set having the same display name as the parameter set to be activated nor a parameter set having the same URL as the parameter set to be activated is already registered (S311: NO and S312: NO), in S315 the CPU 11 determines whether a parameter set has already been registered in each block of the external function parameter information 221 associated with a management ID. In other words, in S315 the CPU 11 determines whether the external function parameter information 221 is in a storage full state, i.e., the external function parameter information has no free block. Here, the free block refers to a block not currently allocated and a block available for allocation. The free block may be referred to as an unused block or an empty block. In the example shown in FIG. 10, ten storage blocks have been allocated in the external function parameter information 221, and each block has been assigned a unique management ID. In other words, the number of parameter sets that can be registered in the external function parameter information 221 has an upper limit. When the CPU 11 determines that a parameter set has already been registered in every block, leaving no free blocks (S315: YES), in S316 the CPU 11 determines that a storage full error has occurred. The upper limit 10 defined by the ten storage blocks is an example of the predetermined number.

Since the number of parameter sets that can be registered in the external function parameter information 221 has the upper limit, the number of external function parameter sets 31 that can be set to active parameter sets also has an upper limit. In this way, the MFP 1 avoids activating a large number of parameter sets that would cause control based on the active parameter sets to be complicated.

After determining that an error occurred in S313 or S316, in S318 the CPU 11 determines that activation has failed and ends the function activation process. In this case, the CPU 11 discontinues the process for activating the external function parameter set 31 and returns to the parameter activation process of FIG. 8.

When the CPU 11 determines that the external function parameter information 221 has a free block in which no parameter set has been registered (S315: NO), in S321 the CPU 11 selects the management ID associated with this free block for the parameter set being activated. In S322 the CPU 11 associates the parameters in the external function parameter set 31 with the selected management ID and stores the parameters in that free block of the external function parameter information 221 to register the external function parameter set 31. In S323 the CPU 11 sets the function setting for the external function to a value indicating ON based on the function setting information 315 of the external function parameter set 31. The CPU 11 may store this value as the function setting data in in the memory 12. The function setting value stored in the memory may be updated each time a new external function parameter set is registered in the function parameter information 221 or the function setting 75 is set by the user through the screen 70 shown in FIG. 4B. By storing activated parameter sets in the memory 12 in units of blocks, the MFP 1 can more easily manage the parameter sets. The series of processes of S322 and S323 is an example of the activation process.

For example, when block B2 shown in FIG. 10 is a free block, the CPU 11 sets the management ID to “02” and writes the registration ID information 311, display name information 312, URL information 313, and execution condition information 314, which are the parameters included in the external function parameter set 31 (see FIG. 4A), to block B2. In other words, in S322 the CPU 11 registers the parameters contained in the external function parameter set 31 in the same manner as when receiving a registration instruction in the registration screen 70 (see FIG. 4B). Specifically, the CPU 11 performs the same process as when a registration instruction is received by inputting the registration ID information 311 into the registration ID 71, the display name information 312 into the display name 72, the URL information 313 into the URL 73, and the execution condition information 314 into the execution condition 74.

When a parameter set whose execution condition has the same timing as that indicated in the execution condition information 314 of the external function parameter set 31 is already registered in the external function parameter information 221, the CPU 11 may treat this situation as an error and skip S322, thereby restricting the MFP 1 from having to execute processes of multiple external functions at the same timing.

In S325 the CPU 11 determines that activation is completed successfully, ends the function activation process, and returns to the parameter activation process in FIG. 8. Note that the CPU 11 may skip S323 when the function setting is already set to a value indicating ON.

Here, the external function program 22 will be described. The external function program 22 is programmed to access the instruction server 7 based on a parameter set registered in the external function parameter information 221 under a condition including a requirement that the function setting is ON. In other words, the external function program 22 does not access the instruction server 7 when the function setting for the parameter set registered in the external function parameter information 221 is OFF. Note that the external function program 22 is programmed to be able to access the activation server 5 indicated by the activation server information 24 regardless of whether the function setting is ON or OFF.

Since the function setting is set to ON in S323 of the function activation process, the MFP 1 executing the external function program 22 will be able to access the external server at the URL specified by the URL information 313 of the activated external function parameter set 31 when the execution condition specified in the execution condition information 314 of the external function parameter set 31 activated in S322 has been met.

For example, when a parameter set for periodic management is stored as an inactive external function parameter set 31 and this external function parameter set 31 is activated, the MFP 1 can perform a process to transmit periodic management information to the management server 6 according to the external function program 22. As an example, the external function parameter set 31 for management may include the registration ID information 311 and display name information 312 specifying parameters for using the management server 6, the URL information 313 specifying a resource of the management server 6, and the execution condition information 314 specifying the timings for accessing the management server 6. The execution condition information 314 may specify a requirement under which access to the management server 6 is triggered. When the parameter set is for periodic management, the execution condition information 314 includes information indicating the periodic timing, such as every 8 hours. Each parameter included in the external function parameter set 31 in this case is an example of the management parameter. The URL information 313 is an example of the management destination information and an example of the management address information. The execution condition information 314 is an example of the condition information.

When the external function parameter set 31 for periodic management is successfully activated, the MFP 1 in accordance with the external function program 22 will then access the management server 6 specified by the activated URL information 313 (or, the URL 73) at a timing specified by the activated execution condition information 314 (or, the execution condition 74). For example, the MFP 1 accesses the management server 6 periodically when the execution condition information 314 specifies a periodic execution timing.

As described above, the management server 6 is configured to send management instruction data 601 (see FIG. 1) to the MFP 1 accessing the management server 6. In accordance with the external function program 22, the MFP 1 receives the management instruction data 601 from the management server 6 and performs operations according to this management instruction data 601. For example, when the management instruction data 601 is instruction data that includes an instruction to transmit a status of the MFP 1 for management to the management server 6, the MFP 1 transmits information on the status of the MFP 1 to the management server 6. The execution condition 74 defining the execution timing is an example of a predetermined access condition.

A value specifying a user instruction can be registered in the external function parameter information 221 as the execution condition 74. When the function setting 75 is a value indicating ON and a parameter set whose execution condition 74 indicates that a user instruction is received has been registered in the external function parameter information 221, the MFP 1 accesses the server specified by the URL 73 in that parameter set on the condition that a user instruction has been received. The MFP 1 may display an icon in the standby screen corresponding to the parameter set whose execution condition 74 indicates that a user instruction is received, in such a manner that a user instruction can be received through that icon. In this case, the MFP 1 may display the display name contained in that parameter set in association with the icon. When multiple parameter sets whose execution condition 74 indicates that a user instruction is received have been registered, the MFP 1 may display an icon for each parameter set. The MFP 1 may also display icons corresponding to every registered parameter set in the standby screen, regardless of the values of their execution conditions 74.

When activation performed in this way is successful, the external function parameter set 31 becomes an activated parameter set. Specifically, all parameters contained in the external function parameter set 31 become registered in the external function parameter information 221 and can be used for controlling the MFP 1. After the external function parameter set 31 is activated, the MFP 1 can perform processes according to the external function program 22 based on the parameters contained in the external function parameter set 31.

When using the management server 6 to perform periodic management of the MFP 1, for example, the user can register parameters in the external function parameter information 221 by inputting each of the parameters into the registration screen 70 (see FIG. 4B) and issuing a registration instruction. However, in the MFP 1 of this embodiment, an external function parameter set 31 containing a plurality of parameters for accessing the management server 6 is stored in the memory 12 in advance. Accordingly, when the user operates the icon the parameter set can be activated, thereby reducing the time and effort for setup operations for using the management server 6.

Note that after the MFP 1 has activated the external function parameter set 31 through the function activation process and has registered the parameters of the external function parameter set 31 in the external function parameter information 221, the MFP 1 can still accept instructions to modify the registered parameters through operations in the registration screen 70 displayed on the user interface 13. In a case where the MFP 1 receives an instruction to display the registration screen 70 for this registered parameter set after activating the external function parameter set 31 and registering the parameters of the external function parameter set 31 in the external function parameter information 221 in S322, the MFP 1 reflects each of the registered parameters in the display of the registration screen 70. When the MFP 1 then receives input for a different parameter from the parameter currently displayed for any of the setting items, the MFP 1 changes the parameter registered in the external function parameter information 221 based on the newly inputted parameter. Thus, the MFP 1 is user-friendly since the user can modify some of the parameters contained in the external function parameter set 31 after activation.

The user can also register a custom parameter set through operations in the registration screen 70. For example, the user may store instruction data on a server to which the MFP 1 can connect and may register parameters including a URL specifying that server in the external function parameter information 221. The designer of the system including the MFP 1 and the servers can store instruction data including print commands or scan commands on the server specified by the URL in this parameter set and can control the MFP 1 to print or scan when the execution condition is satisfied.

The various instruction data stored on each server may also include an instruction to acquire the next instruction data. The next instruction data is the instruction data to be received after processing of the current instruction data is completed. For example, when instruction data contains a URL for requesting the transmission of next instruction data, the MFP 1 can use the URL included in the instruction data to access the specified server and receive the next instruction data. The designer of the system that includes the MFP 1 and the servers can design a system that stores multiple sets of instruction data on each server and that implements a series of processes based on the multiple sets of instruction data by having the MFP 1 perform operations based on the instruction data.

The external function parameter information 221 may be stored in a nonvolatile storage area within the memory 12 of the MFP 1 or may be stored on another storage medium accessible by the MFP 1. For example, the external function parameter information 221 may be stored in USB memory connected to the MFP 1, in a storage such as a hard disk drive of a personal computer connected to the MFP 1, or in a network-attached storage connected to the MFP 1. In any of these cases, the MFP 1 can read the external function parameter information 221 from the storage location into RAM for use at startup or other timings, provided that the function setting is ON.

Returning to the parameter activation process in FIG. 8, when in S201 the CPU 11 determines that the parameter set to be activated is not the external function parameter set 31 but is the configuration parameter set 32 (S201: configuration parameter set), in S211 the CPU 11 reads the specified configuration parameter set 32. For example, when in A11 (FIG. 2) the CPU 11 receives an operation on the activation icon 62 in the selection screen 60 shown in FIG. 3B, the parameter set to be activated is the configuration parameter set 32. That is, in A15 of FIG. 2 the MFP 1 transmits information specifying the configuration parameter set 32 to the activation server 5 and in A16 receives the activation instruction data 502 (see FIG. 7) containing <Setting Number> information 522 specifying the configuration parameter set 32.

In S212 the CPU 11 stores each of the parameters contained in the configuration parameter set 32 read in S211 in a predetermined storage area of the memory 12, for example, to apply those parameters. The process of S212 is an example of the activation process.

For example, the MFP 1 can store a parameter set with power-saving settings for reducing the power consumption of the MFP 1 as the configuration parameter set 32. The configuration parameter set 32 with power-saving settings is an eco mode parameter set. The eco mode parameter set may include panel settings information 321, power settings information 322, and sleep time information 323 shown in FIG. 5A, for example. Each parameter included in the configuration parameter set 32 is an example of the power saving parameter set.

The parameters included in the panel settings information 321 of the configuration parameter set 32 are parameters for reducing power consumption of the touchscreen 131. For example, the panel settings information 321 may include a parameter to darken the screen by turning off or dimming the backlight, a parameter that enables control of the backlight, and a parameter specifying the timing for implementing these controls. The panel settings information 321 is an example of the parameter for reducing or saving the power consumption of the touchscreen 131.

Examples of parameters included in the power settings information 322 of the configuration parameter set 32 are a parameter enabling control for automatically turning off the power to the MFP 1, and a parameter specifying the idle time (duration with no operations) until power to the MFP 1 is automatically turned off.

Examples of parameters included in the sleep time information 323 of the configuration parameter set 32 are a parameter enabling control for placing the printing engine 15 in a sleep state, and a parameter specifying the idle time (duration with no processing) until the printing engine 15 is placed in a sleep state. The sleep time information 323 is an example of the parameter for reducing or saving the power consumption of the printing engine 15.

The MFP 1 can display registration screens that accept input via the user interface 13 for assigning a parameter to each setting item for the configuration parameter set. For example, in response to user instructions, the MFP 1, as illustrated in FIG. 5B, can display a settings screen 81 for accepting panel settings, a settings screen 82 for accepting automatic power-off settings, and a settings screen 83 for accepting sleep time settings. The screens 81-83 are examples of the setting screen.

When the parameter set read in S211 is an eco mode parameter set with the power-saving settings shown in the example of FIG. 5A, in S212 the CPU 11 activates the configuration parameter set 32 by applying each parameter in the configuration parameter set 32 to the respective setting. Specifically, the CPU 11 sets each parameter included in the configuration parameter set 32 as the effective setting value in the same manner as when a setting instruction is received through an operation in the settings screens 81-83.

By activating the configuration parameter set 32, the user can apply all parameters collectively, without having to display the settings screens 81-83 and perform input operations in each. By setting the configuration parameter set 32 to an active parameter set, the MFP 1 can set a plurality of parameters for reducing power consumption, thereby reducing the user's time and effort for configuring settings to reduce power consumption.

Even when the various parameters for power-saving settings have already been set through user operations, in S212 the CPU 11 overwrites these parameters. Thus, even when the user has modified various parameters, for example, the user can apply the various parameters contained in the configuration parameter set 32 by operating the activation icon 62.

After all parameters in the configuration parameter set 32 have been set in S212, in S213 the CPU 11 determines that activation is completed successfully. In other words, after the MFP 1 has activated the configuration parameter set 32, each parameter in the configuration parameter set 32 is set as the corresponding setting. Instead of reaching a successful determination in S213, the CPU 11 may determine that activation has failed in a case where parameters could not be configured for some reason, such as the power being turned off during the configuration process.

Following S213 or after completing the function activation process of S202, the CPU 11 ends the parameter activation process and returns to the activation procedure in FIG. 2.

The MFP 1 can display the settings screens 81-83 and can accept input in the settings screens 81-83 even after having activated the configuration parameter set 32. When displaying the settings screens 81-83 after the configuration parameter set 32 has been activated, the MFP 1 displays the settings screen while reflecting the parameters in the configuration parameter set 32 as the values of the respective settings items. When the MFP 1 receives input in the settings screens 81-83 via the user interface 13 for parameters different from those in the configuration parameter set 32, the MFP 1 performs control according to the different parameters thereafter. Thus, the MFP 1 is user-friendly since the user can modify some of the parameters in the configuration parameter set 32 after activation.

Returning to the description of the activation procedure in FIG. 2, when the MFP 1 determines that activation is completed successfully in the parameter activation process (alt: success), in A31 the CPU 11 restarts the MFP 1 when a restart is required (opt: restart required). Through this process, the various activated parameters are applied to control of the MFP 1.

However, when the CPU 11 determines that activation has failed in the parameter activation process (alt: failure), in A32 the MFP 1 transmits error information including information about the activation failure to the activation server 5. In A33 the MFP 1 also reports the activation failure via the user interface 13. The MFP 1 may receive information representing this report screen from the activation server 5.

Next, the hidden function parameter set 33 will be described. The MFP 1 can store the hidden function parameter set 33 (see FIG. 1) in the pre-activation information 25. The hidden function parameter set 33 is a parameter set for enabling hidden functions that are disabled when the MFP 1 is shipped from the factory or delivered to the customer. The hidden function parameter set 33 includes a plurality of hidden function parameters. Examples of hidden function parameters are parameters enabling paper sizes settings for extended long paper printing, and parameters enabling a function for writing operation logs to USB memory in a debug mode. The extended long paper printing refers to a printing mode that supports elongated sheets longer than standard sizes such as A4 or A3, enabling continuous printing of information or graphics on extended-length media.

While no one has logged in to the MFP 1, an activation icon for the hidden function parameter set 33 is not displayed in the selection screen 60 (see FIG. 3B). However, the MFP 1 may be able to receive an instruction for activating the hidden function parameter set 33 when an administrator or maintenance person of the MFP 1 has logged in to the MFP 1 or when a prescribed instruction is received from an external device such as a personal computer connected to the MFP 1, for example.

When the MFP 1 is in a state for accepting an instruction to activate the hidden function parameter set 33, in A03 of FIG. 2 the MFP 1 transmits information indicating that the hidden function parameter set 33 is stored in the pre-activation information 25 to the activation server 5 together with information on the external function parameter set 31 and configuration parameter set 32. In this way, the MFP 1 receives display instruction data from the activation server 5 including information on an activation icon that accepts an instruction to activate the hidden function parameter set 33. When an operation on this icon is received, the MFP 1 can receive activation instruction data from the activation server 5 for activating the hidden function parameter set 33.

The MFP 1 stores a parameter set containing a plurality of parameters for enabling hidden functions in an inactive state as the hidden function parameter set 33 and can accept an instruction to activate this hidden function parameter set 33. When the hidden function parameter set 33 becomes an activated parameter set in response to the received instruction, the hidden functions are enabled. The user can easily perform an operation to activate the hidden function parameter set 33, thereby reducing the time and effort to set up the hidden functions for use.

As described above in detail, the MFP 1 of the present embodiment stores the external function parameter set 31, configuration parameter set 32, and hidden function parameter set 33, which are parameter sets containing a plurality of parameters each, in the memory 12 in advance as inactive parameter sets. In response to receiving the activation instruction data 502 containing an activation command from the activation server 5, the MFP 1 sets this inactive parameter set to an activated parameter set and thereafter performs control according to the parameters included in the activated parameter set. This enables the MFP 1 to perform control according to those parameters, without receiving a user operation to input the parameters into the MFP 1. Accordingly, this configuration reduces the time and effort of the user for setup.

In the MFP 1 of the embodiment, the external function parameter set 31, which is a parameter set used for external functions, is prepared in advance as an inactive parameter set. When the user wishes to use this external function parameter set 31, the user operates the activation icon 61 to have the activation server 5 transmit the activation instruction data 502 to the MFP 1 in order to make the external function parameter set 31 an activated parameter set. Therefore, even when a user unfamiliar with the external functions of the MFP 1 and the method for setting up those functions, the user can utilize specific functions in accordance with their parameter sets, without having to input the parameters for configuring the external functions.

The first embodiment may be modified in various ways.

For example, the MFP 1 is configured to receive the activation instruction data 502 containing an activation command from a server, such as the activation server 5, via the network 200, but the MFP 1 may receive the activation instruction data 502 from an external device other than a server, provided that the MFP 1 can connect to the external device and that the external device can transmit the activation instruction data 502. For example, the MFP 1 may receive an activation command from a personal computer on which an application program capable of transmitting the activation command is installed. Information identical to the display instruction data 501 and activation instruction data 502 may also be stored on a server other than the activation server 5.

While the destination for transmitting information about an operation on the Web icon 51 (see FIG. 3A) and the destination for transmitting information about an operation on the activation icons 61 and 62 (see FIG. 3B) are both the activation server 5 in the above embodiment, these destinations may be different devices. Further, while in the embodiment the activation icon 61 and activation icon 62 are included in the selection screen 60, the MFP 1 may include these icons in the display of the standby screen 50. For example, the MFP 1 may possess information for displaying the activation icons 61 and 62 in advance. The MFP 1 may not receive the display instruction data 501 in this case, and thus steps A03 and A05 of FIG. 2 may be omitted.

In the above embodiment, the external function parameter set 31 is activated by storing the parameters of the external function parameter set 31 in a single block of the external function parameter information 221 (see FIG. 1). However, the MFP 1 may associate each parameter set with a flag specifying whether the parameter set is active. The MFP 1 may use parameter sets whose associated flag indicates that the parameter set is activated for control of the MFP 1 while not using parameter sets not associated with a flag indicating the parameter set has been activated for control of the MFP 1.

### Second Embodiment

Next, a second embodiment of the present disclosure will be described. Since the basic structures in the second embodiment are identical to those in the first embodiment, only the differences will be described below. Note that steps and components identical to those in the first embodiment are designated with the same step numbers and reference numerals for referencing prior descriptions.

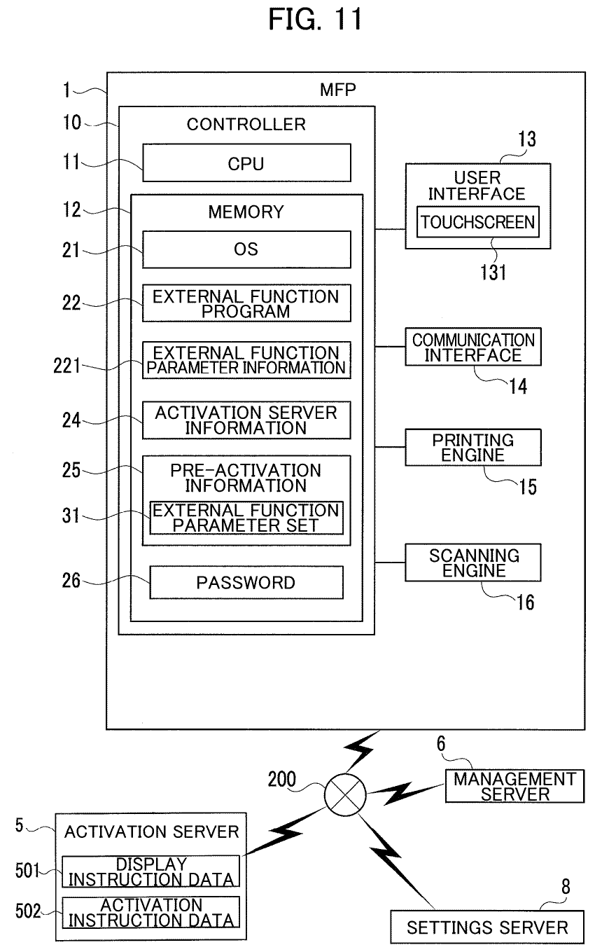

FIG. 11 is a block diagram illustrating an electric configuration of a system including the MFP 1 according to the second embodiment. In the second embodiment, the MFP 1 can access servers via the network 200, including the activation server 5, the management server 6, and a settings server 8. The pre-activation information 25 stores the external function parameter set 31. The pre-activation information 25 may store a plurality of the external function parameter sets and other types of external function parameter sets similarly to the first embodiment.

The memory 12 stores a password 26 in the second embodiment. A predetermined password is registered as the password 26 when the MFP 1 is shipped from the factory. The password of the factory-shipped MFP 1 is noted in a manual delivered with the MFP 1, for example, so that the user can be made aware of the password at the time of delivery. The MFP 1 may perform password authentication prior to executing certain processes. In such cases, the MFP 1 determines that authentication is successful when the password acquired from the user to execute the process matches the password 26 stored in the memory 12, enabling the MFP 1 to execute the prescribed process.

Instruction data stored in the activation server 5 is prepared by the vendor of the MFP 1, for example. The various data stored in the settings server 8 and the management server 6 is prepared by a person in charge of managing the MFP 1, for example. The person in charge of managing the MFP 1 may be a person in charge of the manufacture or sales of MFPs 1, a member of a management company contracted to design and manage a business system that includes the MFP 1, a supplier of the MFPs 1, a service provider contracted to maintain MFPs 1, or a system administrator of a company that has installed MFPs 1, for example.

The activation server 5, settings server 8, and management server 6 may each be an independent device, may be combined as an integrated unit, or may be separate areas in the same cloud service, provided that they are associated with mutually different URLs. The activation server 5 and settings server 8 may also be used by management personnel who manage devices other than MFPs 1. Alternatively, the management personnel of each device may prepare a corresponding management server in addition to the management server 6 used for MFPs 1.

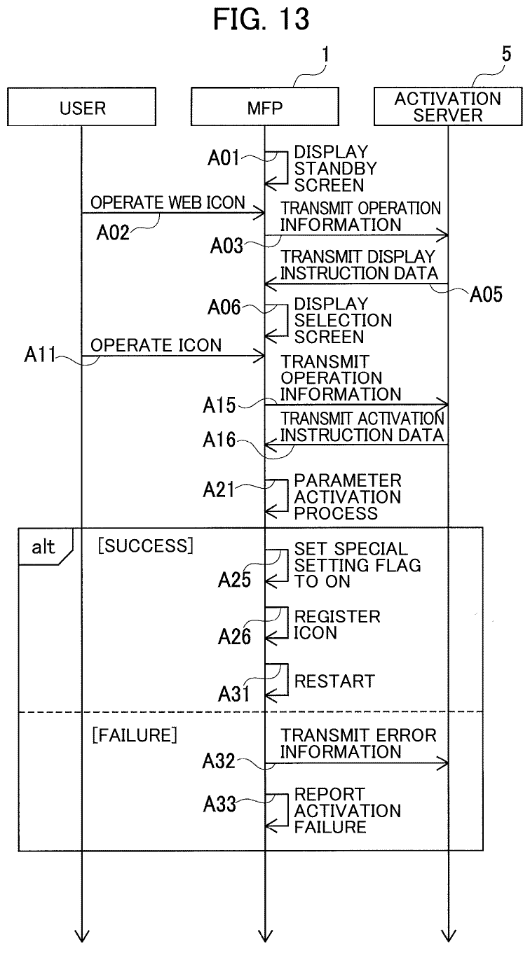

FIG. 13 shows steps for activating a parameter set in the pre-activation information 25 according to the second embodiment. Steps A01-A11 are performed similarly to those steps in FIG. 2 of the first embodiment. When the activation icon 61 (FIG. 3B) is operated, steps A15-A21 are performed. The second embodiment describes an example in which the activation icon 61 is operated is in A11. However, when the activation icon 62 (FIG. 3B) is operated in the second embodiment step A12 shown in FIG. 2 may be performed in the same manner as in the first embodiment.

Similarly to the first embodiment, in A21 the MFP 1 reads the external function parameter set 31 to be activated from the pre-activation information 25 of the memory 12 (see FIG. 11) and activates the external function parameter set 31 by registering each parameter contained in the external function parameter set 31 in the external function parameter information 221 (see FIG. 11).

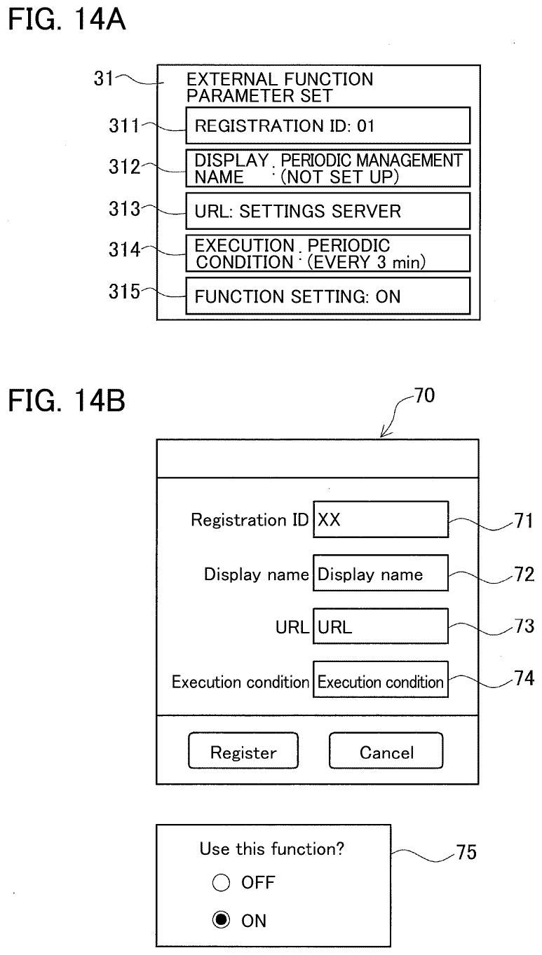

The MFP 1 can also register a parameter set in the external function parameter information 221 according to a different method from activating the external function parameter set 31. For example, the MFP 1 can accept an instruction to register a parameter set in the external function parameter information 221 via the registration screen 70 shown in FIG. 14B. The MFP 1 can display the registration screen 70 on a browser of an external device, which is an example of the user interface 13. The MFP 1 may also display the registration screen 70 on the touchscreen 131, which is an example of the user interface 13.

The MFP 1 can accept input of the registration ID 71, display name 72, URL 73, and execution condition 74 in the registration screen 70 as various parameters to be included in the parameter set. When the MFP 1 receives an instruction to register the parameter set via the registration screen 70, the MFP 1 stores a parameter set containing the inputted parameters in the external function parameter information 221.

The registration ID 71 is information for identifying a parameter set registered in the external function parameter information 221. The display name 72 is the name of the parameter set. The MFP 1 uses the display name 72 when displaying information specifying the parameter set on the user interface 13. The URL 73 is information indicating the server to be accessed by the external function program 22. The URL 73 is information specifying a resource possessed by the server to be accessed but is described as information indicating the server, for example. The execution condition 74 is information specifying timings at which the external function program 22 is to access the destination indicated by the URL 73. The execution condition may be information specifying a prescribed interval that is repeated or information specifying specific timings, such as a certain time on a particular day of every week, when the power is turned on, and when a prescribed operation is received from the user.

The MFP 1 can also accept an instruction to switch the screen displayed on the touchscreen 131 from the registration screen 70 to a screen for accepting an operation to specify a function setting 75. The function setting 75 indicates whether to enable use of the external function parameter information 221 with external functions. The value of on the set function setting 75 may be stored in the memory 12 in association with the external function parameter set information 221. When the function setting 75 is ON, the MFP 1 checks the execution conditions in the parameter sets registered in the external function parameter information 221 in accordance with the external function program 22. When the execution condition is satisfied, the MFP 1 uses the registered URL to perform an access process. In other words, the external function program 22 is configured so that the MFP 1 executes a process based on the parameter set registered in the external function parameter information 221 under a condition including a requirement that the function setting is ON. Similarly to the first embodiment, the functional setting may be assigned for each parameter set stored in a corresponding block in the external function parameter information 221.

When the function setting 75 is not ON, on the other hand, the MFP 1 does not check the execution condition, even when a parameter set is registered in the external function parameter information 221. However, when the MFP 1 received instruction data to perform a process using the parameter set, the external function program 22 can execute a process based on that instruction data whether the function setting 75 is ON or OFF.

Each parameter contained in the external function parameter set 31 corresponds to a parameter contained in a parameter set registered through the registration screen 70 shown in FIG. 14B. As shown in the example of FIG. 14A, the external function parameter set 31 includes registration ID information 311, display name information 312, URL information 313, execution condition information 314, and function setting information 315. Each parameter in the external function parameter set 31 corresponds to a parameter inputted into a field of the registration screen 70. Specifically, the registration ID information 311 corresponds to the registration ID 71, the display name information 312 to the display name 72, the URL information 313 to the URL 73, the execution condition information 314 to the execution condition 74, and the function setting information 315 to the function setting 75. The MFP 1 may be capable of displaying each parameter in the external function parameter set 31 in the registration screen 70 and may be able to accept operations via the registration screen 70 for editing these parameters.

Returning to the description of the activation procedure in FIG. 13, in A21 the MFP 1 registers the parameter set specified by the activation instruction data 502 received in A16 in the same manner as when the MFP 1 receives a registration instruction through the registration screen 70. Specifically, the MFP 1 registers the parameters 311-315 contained in the external function parameter set 31 in the external function parameter information 221. As a result, the function setting is set to ON, and the external function parameter set 31 is stored in the memory 12 in a valid state so as to be utilized when executing the external function program 22.

As an example, when the external function parameter set 31 shown in FIG. 14A has been activated, a parameter set with a registration ID of “01”, a display name of “periodic management (not set up),” a URL of “settings server,” and an execution condition of “repeated (every 3 minutes)” is registered in the external function parameter information 221. The execution condition 314 is an example of the access condition. The URL information 313 is an example of the first destination information indicating the first destination and an example of the first address information indicating the first address.

The external function program 22 may have a function for automatically assigning a registration ID with which no other parameter set has been registered as the registration ID 71 when receiving an instruction to register a parameter set. With the MFP 1 having this configuration, the external function parameter set 31 may not include registration ID information 311.

Returning to the description of the activation procedure in FIG. 13, when the MFP 1 determines that the external function parameter set 31 has been successfully activated (alt: success), in A25 the MFP 1 sets a special setting flag to ON. The special setting flag is information indicating that the duration elapsed since activation of the external function parameter set 31 is within a predetermined time length. The special setting flag indicating ON, that is, indicating that the elapsed duration is within the predetermined time length, is an example of the information indicating the special mode is enabled. The process of A25 is a example of the mode enabling process.

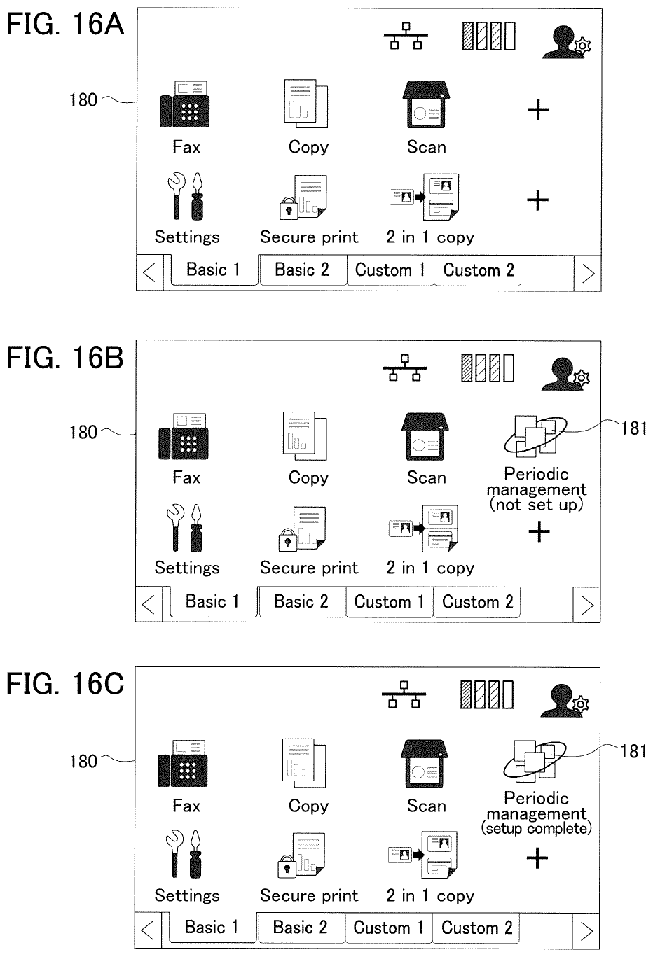

In A26 the MFP 1 also registers information in the memory 12 for an icon representing the activated external function parameter set 31. The MFP 1 can display icons in a home screen (or standby screen) to accept user operations for parameter sets registered in the external function parameter information 221. When the external function parameter set 31 is registered in the external function parameter information 221, the MFP 1 records information on an icon 181 shown in FIG. 16B, for example. The information on this icon 181 is registered in the memory 12 as information for displaying both an image of the icon 181 and a text “periodic management (not set up)” indicating the display name 72 of the external function parameter set 31. The information on the icon 181 may include image data representing the icon. The image data may be incorporated in the external function program 22 in advance and the information on the icon 181 may include information specifying the image data. Alternatively, the MFP 1 may be able to acquire the image data from an external device, such as the activation server 5, or may be able to receive a user designation of the image data.

In A31 the MFP 1 restarts. Note that in A25 the MFP 1 stores information on the special setting flag in a nonvolatile storage area of the memory 12 so the MFP 1 can reference the information after restarting. In A26 the MFP 1 also stores information on the icon in a nonvolatile storage area of the memory 12.

On the other hand, when the MFP 1 determines that activation of the external function parameter set 31 has failed due to an error occurring during the process (alt: failure), in A32 the MFP 1 transmits error information to the activation server 5 including information on the activation failure. In A33 the MFP 1 also reports the failure to activate the external function parameter set 31 via the user interface 13. The MFP 1 may receive information representing a notification screen from the activation server 5. The MFP 1 may also change the function setting from OFF (disabled) to ON (enabled), and then return the function setting to OFF when registration of the parameter set fails in a future process.

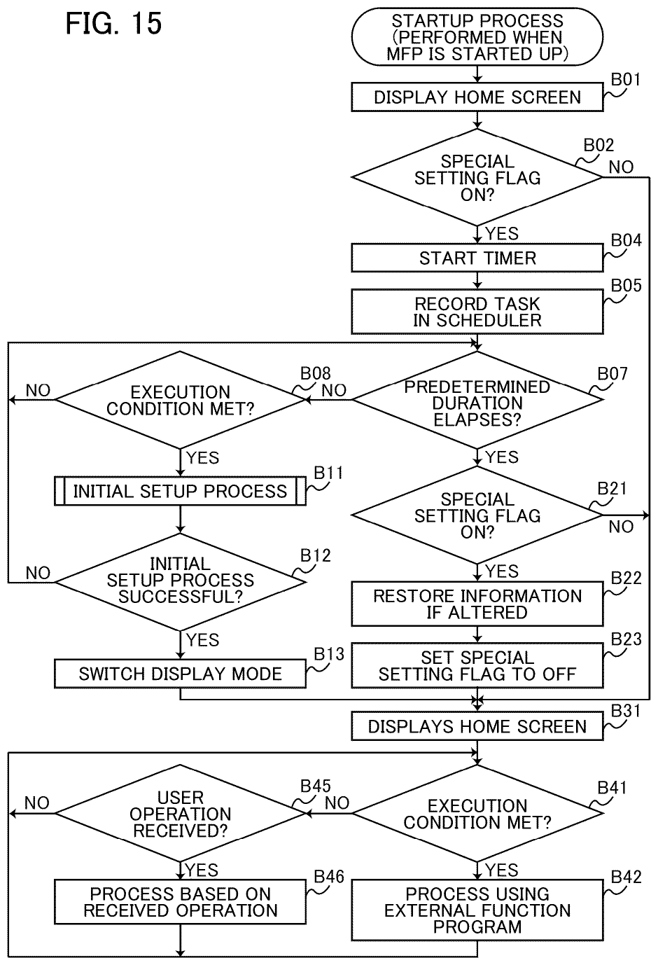

Next, steps in a startup process will be described with reference to the flowchart in FIG. 15. The CPU 11 of the MFP 1 executes the startup process when the MFP 1 is started up, such as after the restart in A31.

At startup, in B01 the CPU 11 displays a home screen (or standby screen) on the touchscreen 131 of the user interface 13. Prior to executing the activation procedure in FIG. 13, the CPU 11 displays a home screen 180, as shown in the example of FIG. 16A. The home screen 180 includes a plurality of icons that can accept user operations. The home screen 180 may be transitioned to the standby screen 50 (FIG. 3A) through a user operation.

In a case where the activation procedure shown in FIG. 13 has been successfully completed, an icon 181 that has been recorded in the memory 12 in A26 of the activation procedure is added to the home screen 180 when the MFP 1 is restarted in A31, as shown in the example of FIG. 16B. The icon 181 accepts an execution instruction to perform a process based on the parameter set registered in the external function parameter information 221 in the activation procedure (i.e., the external function parameter set 31). That is, when an operation on the icon 181 is received, the external function program 22 can access the destination specified by the URL information 313 as a process based on the external function parameter set 31. In the following description, the parameter set registered in the external function parameter information 221 based on the external function parameter set 31 may be referred to simply as “the external function parameter set 31.”

In B01 of the startup process following the restart in A31 of FIG. 13, the CPU 11 displays the icon 181 with the display name “periodic management (not set up),” as shown in the example of FIG. 16B. This display mode of the icon 181 indicates that while activation of the external function parameter set 31 has been completed, an initial setup process described later has not been completed. The icon 181 is an example of the access icon. The home screen 180 including the icon 181 is an example of the standby screen.

In B02 the CPU 11 determines whether the special setting flag is ON. As described above, the MFP 1 sets the special setting flag to ON when activation of the external function parameter set 31 has been completed successfully. When the CPU 11 determines that the special setting flag is ON (B02: YES), in B04 the CPU 11 starts a timer. In B05 the CPU 11 also records a task in the scheduler to turn off the special setting flag once a predetermined duration has elapsed from the start of the timer. Accordingly, the special setting flag will be turned off by the scheduler after the predetermined duration has elapsed, even when the startup process is not executed properly.

In B07 the CPU 11 determines whether the predetermined duration (predetermined period of time) has elapsed since the start of the timer. When the CPU 11 determines that the predetermined duration has not elapsed (B07: NO), in B08 the CPU 11 determines whether the execution condition indicated by the execution condition information 314 of the external function parameter set 31 is met. When the CPU 11 determines that the execution condition is not met (B08: NO), the CPU 11 repeats the determinations in B07.

Here, the function setting is ON when the external function parameter set 31 has been successfully activated. Therefore, for each parameter set registered in the external function parameter information 221, the MFP 1 performs a process based on the execution condition contained in that parameter set, that is, the MFP 1 performs the process according to the parameter set when the execution condition in the parameter set is satisfied. For example, when the execution condition information 314 in the external function parameter set 31 indicates that the process is to be repeated every three minutes, the CPU 11 determines that the execution condition based on the external function parameter set 31 is satisfied each time three minutes elapses, after the start of the MPF 1 (after B01 is executed, for example).

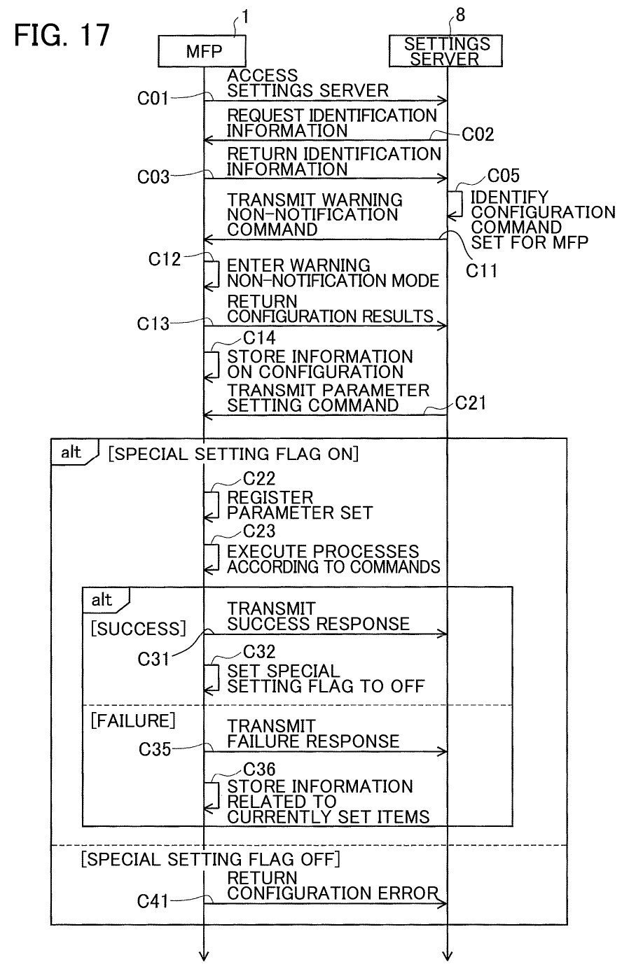

When the CPU 11 determines that the execution condition of the external function parameter set 31 is satisfied (B08: YES), in B11 the CPU 11 executes an initial setup process. The initial setup process is executed by the external function program 22 using the external function parameter set 31. Steps in the initial setup process will be described next with reference to the sequence diagram in FIG. 17.

In C01 of the initial setup process, the MFP 1 first accesses the settings server 8 based on the URL information 313 in the external function parameter set 31. When the settings server 8 accepts access to the destination indicated by the URL information 313 of the external function parameter set 31, in C02 the settings server 8 requests identification information from the source of this access. The identification information is unique information identifying the device. The process of C91 is an example of the first access process. The settings server 8 is an example of the first destination and an example of the first address information.

In response to the request in C02, in C03 the MFP 1 returns information to the settings server 8 containing information identifying the MPF 1 itself (identification information). The information identifying the MFP 1 is registered in a management information base (MIB) stored in the memory 12, for example. Based on the identification information received in C03, in C05 the settings server 8 identifies a set of configuration commands to return to the MFP 1 (i.e., the source of the transmitted identification information).

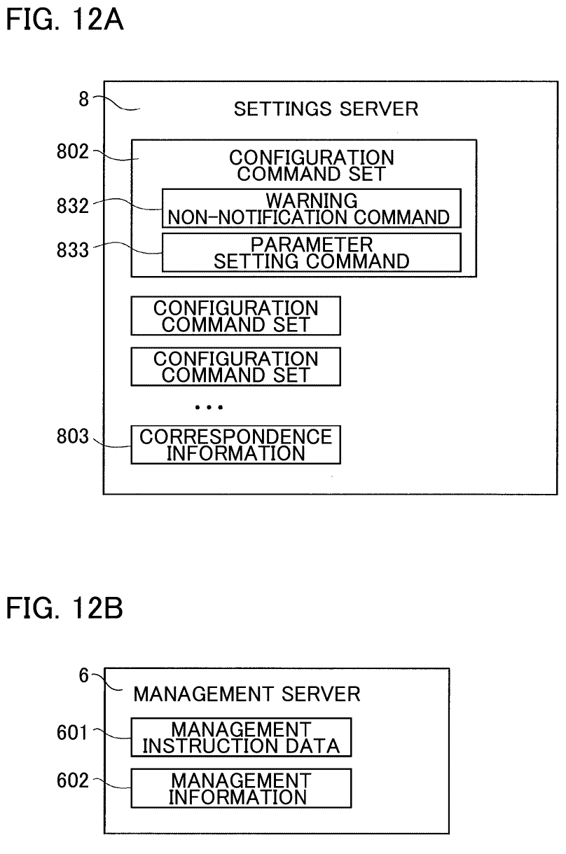

As shown in the example of FIG. 12A, the settings server 8 stores one or more configuration command sets 802 and correspondence information 803 in a memory (not shown) of the settings server 8. The correspondence information 803 specifies correlations between identification information for each accessing device and the configuration command set 802 to be applied to that device. The settings server 8 can specify the configuration command set 802 associated with the MFP 1 accessing the settings server 8 by referencing the correspondence information 803.

In this embodiment, the settings server 8 is used by a person in charge of managing the MFP 1 and a person in charge of each of a plurality of other devices (not shown). The person in charge of managing each device stores a configuration command set to be applied to the corresponding device in the settings server 8. The person in charge of each device also registers, in the correspondence information 803, information mapping the identification information for the device of which the person is in charge to the registered configuration command set. When the identification information received in C03 is not registered in the correspondence information 803, the settings server 8 may end the initial setup process without executing the steps from C05. Further, when the identification information received in C03 is not registered in the correspondence information 803, the settings server 8 may specify a configuration command set 802 that includes a warning non-notification command 832, and a parameter setting command 833 as the specified configuration command set to be returned.

In C11 the setting server transmits a command included in the specified configuration command set 802 to the MFP 1. In this example, a case is described where the specified configuration command set 802 contains the warning non-notification command 832 and the parameter setting command 833. In this case, in C11 the settings server 8 first transmits the warning non-notification command 832 to the MFP 1.

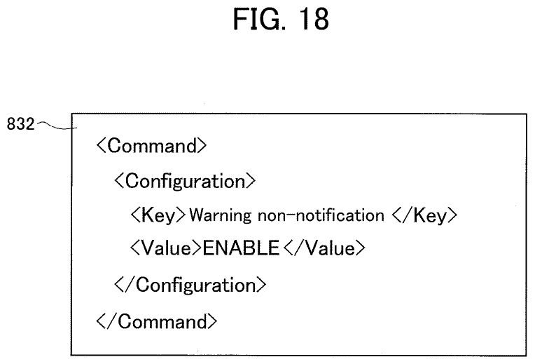

As shown in the example of FIG. 18, the warning non-notification command 832 specifies an instruction for configuring the MFP 1 not to issue a warning based on the depleted level (consumed level) of a consumable. For example, the MFP 1 has a function for issuing a first-type warning indicating that the residual quantity of consumable is reduced (or depleted) when the residual quantity of a consumable such as a colorant falls below a certain amount but the residual quantity still remains and further issuing a second-type warning indicating an error notification when the consumable is completely depleted (no colorant remains). The warning regarding a remaining amount of the colorant is an example of the warning based on the depleted level or the consumed level. The first-type warning indicating the residual quantity of a consumable such as a colorant falls below a certain amount but the consumable is not completely depleted is an example of the first warning indicating that the MFP 1 is in a state that is not the completely depleted state but a state prone to transitioning to the completely depleted state with a small change. The second-type warning indicating that the consumable is completely depleted or that the consumable is significantly depleted in a state where normal printing operation is not ensured is an example of the second warning. The first-type warning is issued when the consumable is in a first state, and the second-type warning is issued when the consumable is in a second state in which the consumable is depleted more than in the first state.

In response to receiving the warning non-notification command 832, in C12 the MFP 1 enters a warning non-notification mode. The warning non-notification command 832 specifies an instruction for the MFP 1 not to issue a first-type warning, even when the residual quantity of colorant drops below a certain amount. The warning non-notification command 832 does not include an instruction to modify the frequency of the second-type warning (error notifications). Following the configuration in C12, the MFP 1 will not issue warning notifications for low levels of colorant but will issue error notifications when colorant is fully depleted. Therefore, the setting in C12 reduces the frequency at which the MFP 1 issues warnings about the residual quantities of consumables. Hence, the process of C12 is equivalent to reducing the frequency of warnings based on the depleted levels of consumables. The process of C12 is an example of the modification process.

As described above in detail, the MFP 1 sends information to the management server 6 regarding the amounts of consumables used on the MFP 1, e.g., information on the amounts of colorant used, in accordance with the management instruction data 601 transmitted from the management server 6. The person in charge of managing the MFP 1 can check information received by the management server 6. Thus, the person in charge of managing the MFP 1 can arrange for a replacement to be sent to the end user of the MFP 1 when the residual quantity of a consumable becomes low. When the MFP 1 issues a warning about the low residual quantity, the end user may become anxious and replace the consumable when the replacement arrives, even though the current consumable is still usable. Configuring the MFP 1 not to issue a first-type warning in this case can reduce the possibility of causing the end user anxiety so that the user can be expected to use the consumable until completely depleted.

In C13 the MFP 1 returns the configuration results to the settings server 8. In C14 the MFP 1 stores information in the memory 12 indicating that the warning non-notification setting has been configured in the initial setup process. Note that when the warning non-notification setting is already configured when the MFP 1 receives a command in C11, in C13 the MFP 1 returns information to the settings server 8 indicating that the setting has already been made and subsequently skips C14.

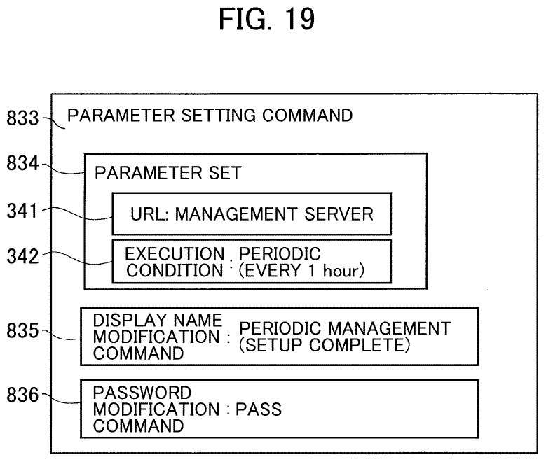

After receiving a response in C13, in C21 the settings server 8 transmits the parameter setting command 833 identified in C05 to the MFP 1. As shown in the example of FIG. 19, the parameter setting command 833 includes a parameter set 834, a display name modification command 835, and a password modification command 836.

When the special setting flag is ON (alt: special setting flag ON), in C22 the MFP 1 registers the parameter set 834 in the external function parameter information 221 based on the parameter setting command 833 received in C21. The process of C22 is an example of the storing process.

As shown in FIG. 19, the parameter set 834 includes at least URL information 341, and execution condition information 342. Through the process of C22, the MFP 1 effectively stores a parameter set containing the URL information 341 and execution condition information 342 in the memory 12 to be utilized by the external function program 22. As with the external function parameter set 31, the parameter set 834 may also include registration ID information and display name information.

When parameters are registered in the external function parameter information 221 based on the parameter set 834 shown in FIG. 19, for example, the MFP 1 repeatedly accesses the management server 6 (see FIG. 11) every hour, as will be described below. The management server 6 is an example of the second destination and an example of the second address. The URL information 341 indicating the location of the management server 7 is an example of the second destination information and an example of the second address information. The execution condition information 342 is an example of the timing information. The management server 6 will be described later in detail.

In C23 the MFP 1 executes processes according to the various commands in the parameter setting command 833 received in C21. For example, when the parameter setting command 833 contains the display name modification command 835 shown in FIG. 19, the MFP 1 updates information related to the icon 181, which has been recorded in the memory 12 in A26 of the activation procedure (see FIG. 13). Specifically, the MFP 1 updates information on the icon 181 so that the icon 181 is displayed with the display name “periodic management (setup complete)” specified in the display name modification command 835, as illustrated in FIG. 16C. The display name modification command 835 is an example of the switching command.

Further, when the parameter setting command 833 contains the password modification command 836 shown in FIG. 19, the MFP 1 updates the password stored in the memory 12 as the password 26 (see FIG. 11) to the new password specified in the password modification command 836. The password modification command 836 is an example of the password modification command. The process of C23 for updating the password is an example of the updating process.

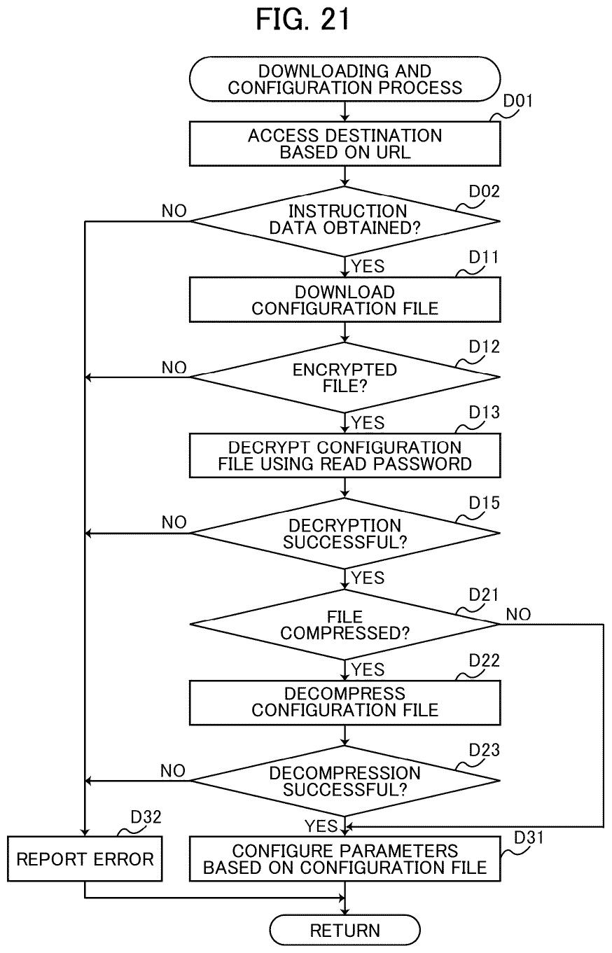

As will be described later with reference to FIG. 21, the MFP 1 can execute a process to decrypt an encrypted configuration file and to configure control parameters of the MFP 1 according to the decrypted configuration file. In the process for configuring control parameters, the MFP 1 performs authentication based on the password 26 in order to decrypt the configuration file. The configuration file may also be compressed. In this case, the MFP 1 may also perform authentication with the password 26 when decompressing the compressed file. The encryption and compression is an example of the encryption and an example of the transformation for data safeguarding.

However, it is troublesome for the person in charge of managing the MFP 1, and particularly a person in charge of managing a plurality of devices including the MFP 1, to keep track of the password for each device. In some cases, the person in charge of managing the MFP 1 may be unable to learn the password 26 without asking the end user of the MFP 1, for example. Even the end user of the MFP 1 may not yet know the password 26 while the value of the password 26 is still the factory-default setting. Therefore, the person in charge of managing the MFP 1 according to this embodiment prepares the parameter setting command 833 in the form of a configuration file that is neither encrypted nor compressed. The configuration file that the MFP 1 receives from the settings server 8 in C21 is neither encrypted nor compressed and has the same format as a (decrypted and decompressed) configuration file downloaded in D11 of a downloading and configuration process described later in FIG. 21.

The person in charge of managing the MFP 1 also prepares the parameter setting command 833 including the password modification command 836 (FIG. 19) to be transmitted to the MFP 1 when executing the initial setup process. When the special setting flag is ON, in C23 the MFP 1 sets the parameter set 834 and password 26 based on the unencrypted configuration file received from the settings server 8. However, when the special setting flag is OFF, the MFP 1 determines that processes based on the unencrypted configuration file cannot be executed and does not configure any settings. The special setting flag is set to ON in A25 of the activation procedure (see FIG. 13) prior to the MFP 1 restarting.

Thus, the MFP 1 according to the present embodiment can execute processes based on the parameter setting command 833 included in an unencrypted file under the condition that the condition that the MFP 1 is started while the special setting flag is ON. Moreover, when the special setting flag is ON, the MFP 1 can update the password 26 to the new password designated in the password modification command 836 included in the parameter setting command 833, without using the current password 26. In other words, the MFP 1 can execute the processes in C22 and C23 of this initial setup process (B11 in the startup process of FIG. 15), provided that the special setting flag is ON.

When the MFP 1 successfully completes the registration in C22 and the processes in C23 (alt: success), in C31 the MFP 1 sends a response to the settings server 8 indicating that the processes in the parameter setting command 833 received from the settings server 8 are completed successfully. In C32 the MFP 1 sets the special setting flag to OFF. Accordingly, thereafter the MFP 1 will not perform any configurations based on unencrypted configuration files. The process of C32 is an example of the mode disabling process.

Since the warning non-notification command 832 and the parameter setting command 833 have different formats in this embodiment, the configuration command set 802 is prepared for instructing the settings server 8 to transmit these commands separately. In a case where the MFP 1 can receive and process the warning non-notification command 832 and the parameter setting command 833 as a single file, the person in charge of managing the MFP 1 may package these commands in a single file for the settings server 8.

When at least one of the registration in C22 and the processes in C23 has failed (alt: failure), in C35 the MFP 1 returns a response to the settings server 8 indicating that the processes in the parameter setting command 833 has failed. When settings for any items have been set during this registration in C22 and processing in C23, in C36 the MFP 1 stores modified-settings information related to settings for the items that have been set. The modified-settings information may include information on previous values for the items that are the settings before execution of C22.

Further, in a case where the special setting flag is OFF when the MFP 1 receives the parameter setting command 833 in C21 (alt: special setting flag OFF), in C41 the MFP 1 returns a configuration error to the settings server 8 and does not execute any processes based on the parameter setting command 833 or warning non-notification command 832. In other words, the MFP 1 does not allow the registration of the parameter set 834 or a password update while the special setting flag is OFF. Following any of C32, C36, and C41, the MFP 1 returns to the startup process in FIG. 15.

Returning to the description of the startup process in FIG. 15, after completing the initial setup process of B11, in B12 the CPU 11 determines whether the initial setup process is completed successfully. When the CPU 11 determines that the initial setup process is completed successfully (B12: YES), in B13 the CPU 11 switches the display mode of icons displayed in the home screen 180 according to the processes executed based on the display name modification command 835 in C23 of the initial setup process. The process of B13 is an example of the icon switching process. The icon 181 with the display name is an example of the display object.

However, when the CPU 11 determines that the initial setup process of B11 is not completed successfully (B12: NO), the CPU 11 returns to the determinations in B07. Thereafter, in a case where the CPU 11 determines that the execution condition is again met before the predetermined duration has elapsed (B08: YES), in B11 the CPU 11 executes the initial setup process again. The CPU 11 may complete the re-executed initial setup process of B11 successfully when the cause of failure in the previous initial setup process has been resolved.

When the CPU 11 determines that the predetermined duration has elapsed (B07: YES), in B21 the CPU 11 determines whether the special setting flag is ON. When the initial setup process of B11 is successfully completed, the special setting flag has been set to OFF in C32 of the process. On the other hand, when the predetermined duration elapsed without the initial setup process being completed successfully, the special setting flag may still be ON.

When the special setting flag is ON when the predetermined duration has elapsed (B21: YES), in B22 the CPU 11 restores any information that may have been altered in the current startup process to their original values. In a case where the process in C36 is performed in the initial setup process shown in FIG. 17, the MFP 1 stores information on settings. As an example, when the CPU 11 was executing the initial setup process of B11 but an error occurred after making the warning non-notification setting, the CPU 11 restores the warning non-notification setting to its previous value based on the modified-settings information.

In B23 the CPU 11 sets the special setting flag to OFF. Accordingly, thereafter the CPU 11 does not execute any processes with the external function program 22 based on an unencrypted file. Although unencrypted files are vulnerable to tampering, the MFP 1 is very secure because the MFP 1 accepts an unencrypted file under a condition that the special setting flag is ON, that is, the MFP 1 accepts the unencrypted file for the predetermined duration after completing the activation procedure for the external function parameter set 31.

Further, the password set as the password 26 is updated normally when authentication using the current password is executed successfully. While the special setting flag is ON, the MFP 1 of the present embodiment can update the password without executing authentication using the current password. However, security may be compromised in a case where the MFP 1 remains for very long in a state that allows the password to be updated without authentication based on the current password. Moreover, in a case where the MFP 1 is capable of accepting any number of password updates, there may be some uncertainty as to which password received at what time is the current password. The MFP 1 sets the special setting flag to OFF after successfully completing an initial setup process including a password update or after a predetermined duration, between 30 minutes and 1 hour, has elapsed, at which time the password can no longer be updated without authentication using the current password. Accordingly, the configuration of this embodiment can restrict password management from becoming too complicated while avoiding a lapse in security.

Following the process in B13 or B23 or when the CPU 11 determines that the special setting flag is OFF (B02: NO or B21: NO), in B31 the CPU 11 displays the home screen 180 on the user interface 13. At this time, the CPU 11 can accept operations in the displayed home screen 180 and can perform processes according to the received operations. In a case where the initial setup process is completed successfully, the CPU 11 displays the home screen 180 as shown in FIG. 16C. Here, the home screen 180 includes the icon 181 having the display name “periodic management (setup complete),” which has been changed in B13. The icon 181 with the display name “periodic management (not set up) is an example of the access icon in a first mode. The icon 181 with the display name “periodic management (setup complete)” is an example of the access icon in a second mode.

When the initial setup process is not completed successfully, the CPU 11 displays the home screen 180 shown in FIG. 16B, which includes the icon 181 having the display name “periodic management (not set up).” The icon 181 with the display name “periodic management (not set up)” may accept an instruction to execute a process based on the activated external function parameter set 31, for example. When the MFP 1 receives an operation on the icon 181 containing this display name “periodic management (not set up),” the MFP 1 can access the settings server 8 specified in the URL information 313 of the external function parameter set 31 that has been activated and registered in the external function parameter information 221.

Since the icon 181 displayed when the initial setup process is completed successfully (i.e., the icon 181 with the display name “periodic management (setup complete)”) has a different display mode from the icon 181 displayed when the initial setup process is not completed successfully, the end user can recognize that the initial setup process is completed successfully. By operating the icon 181 prior to the display mode of the icon 181 being switched, the end user may also be allowed to instruct the MFP 1 to access the settings server 8 based on the activated external function parameter set 31, even when the special setting flag is OFF. For example, in a case where the MFP 1 was unable to complete the initial setup process due to a communication error after successfully activating the external function parameter set 31, the MFP 1 can subsequently accept an instruction to execute the initial setup process through an operation on the icon 181.

Note that the icon 181 containing the display name “periodic management (setup complete)” displayed after the initial setup process is completed successfully is not associated with any process, and even when the icon 181 is operated, the MFP 1 does not perform any action in response to the operation. Therefore, rather than switching the display mode of the icon 181 in B13, the CPU 11 may simply disable the icon 181. In this case, the parameter set 833 (see FIG. 19) may include a disable command for disabling the icon 181 rather than the display name modification command 835 (FIG. 19). The disable command may specify an instruction not to display the icon 181 or may specify an instruction to gray out the icon 181 so that the icon 181 cannot be operated. Disabling this icon can also let the end user know that the initial setup process is completed successfully. The process of B13 in this case is an example of the icon disabling process.

The MFP 1 can execute a process based on each parameter set registered in the external function parameter information 221, provided that the function setting is ON. In B41 the CPU 11 determines whether the execution condition for each parameter set registered in the external function parameter information 221 has been satisfied. When a parameter set including the recurrent execution condition information 342 has been prepared as the parameter set 834, as shown in the example of FIG. 19, the parameter set 834 is registered in the external function parameter information 221 when the initial setup process is successful.

When the CPU 11 determines that the execution condition for a parameter set registered in the external function parameter information 221 is satisfied (B41: YES), in B42 the CPU 11 executes a process with the external function program 22 based on that parameter set. For example, when the CPU 11 determines that the execution condition information 342 in the parameter set 834 is satisfied, the CPU 11 accesses the management server 6 (see FIG. 11) based on the URL information 341 in the parameter set 834. The process of B42 is an example of the second access process.

As shown in the example of FIG. 12B, the management instruction data 601 has been prepared on the management server 6. When a resource on the management server 6 identified by the URL information 341 is accessed, the management server 6 is configured to send the management instruction data 601 to the source of this access. The management instruction data 601 is instruction data containing instructions for managing the MFP 1. The person in charge of managing the MFP 1 prepares this management instruction data 601 on the management server 6. The instructions for managing the MFP 1 may include an instruction requesting the MFP 1 to transmit information on the status of the MFP 1, such as information related to usage quantities of consumables, to the management server 6.

The MFP 1 receives the management instruction data 601 when accessing the management server 6 based on the URL information 341. The MFP 1 then executes a process based on the instructions in the management instruction data 601, whereby the MFP 1 transmits information such as status information to the management server 6. The management server 6 can store information received from the MFP 1 as management information 602, for example. The person in charge of managing the MFP 1 can obtain information on the status of the MFP 1 by accessing the management server 6 and referencing the management information 602.

When the external function parameter set 31, which includes the URL information 313 specifying the settings server 8, has been registered in the external function parameter information 221 in A21 shown in FIG. 13, the MFP 1 accesses the settings server 8 in accordance with the execution condition specified in the execution condition information 314 of the external function parameter set 31. In this way, the person in charge of managing the MFP 1 can register the parameter set 834 on the MFP 1 without any operations for configuring the parameter set 834 by the user. This method is likely to reduce the time and effort for configuring parameters by the user.

When the parameter set 834, which includes the URL information 341 specifying the management server 6, has been registered in the external function parameter information 221 in the initial setup process (C22), the MFP 1 accesses the management server 6 in accordance with the execution condition specified in the execution condition information 342 of the parameter set 834 registered. In this way, the person in charge of managing the MFP 1 can access the management server 6 without having the user to perform any operations for configuring the parameter set 834. This method is likely to reduce the time and effort required for configuring parameters.

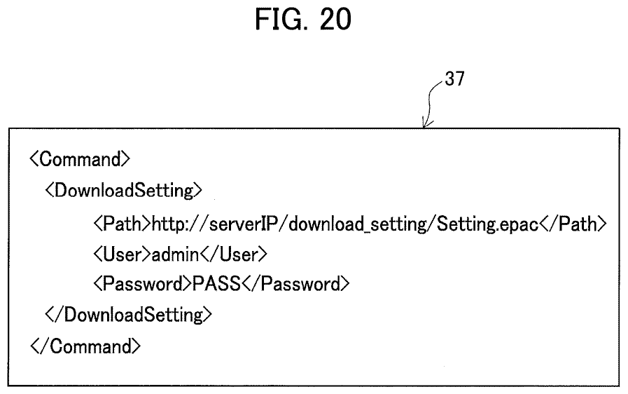

The MFP 1 can register a custom parameter set in response to operations received in the registration screen 70 described above (see FIG. 14B). For example, the person in charge of managing the MFP 1 can store instruction data on a server to which the MFP 1 can connect and can register parameters including a URL specifying the server in the external function parameter information 221. The person in charge of managing the MFP 1 can prepare instruction data 37, as shown in the example of FIG. 20, and a configuration command file (not shown) on a server to which the MFP 1 can connect. When the execution condition of a parameter set registered in the external function parameter information 221 is satisfied, the MFP 1 can receive the instruction data from the access destination indicated by the URL in that parameter set. The execution condition in the parameter set may also be information indicating that a specific user operation is received.

When the instruction data received from the access destination includes a print command or a scan command, for example, the MFP 1 can execute a print or scan based on this instruction data. When the instruction data includes a configuration command instructing the MFP 1 to configure various control parameters used for controlling the MFP 1, for example, the MFP 1 can configure the control parameters based on this instruction data.

When the execution condition of a registered parameter set in the external function parameter information 221 is met, the MFP 1 executes a process based on that parameter set, such as the downloading and configuration process. Here, steps in the downloading and configuration process will be described with reference to the flowchart in FIG. 21. The CPU 11 of the MFP 1 implements this downloading and configuration process according to the external function program 22.

In D01 of the downloading and configuration process, the CPU 11 accesses a destination based on the URL in the parameter set. In D02 the CPU 11 determines whether instruction data has been obtained as a result of the access in D01 and determines whether the instruction data indicates instructions to download a configuration file and to configure control parameters based on this configuration file. For example, the CPU 11 may obtain the instruction data 37 shown in FIG. 20. The instruction data 37 instructs the MFP 1 to download a configuration file and to configure control parameters based on this configuration file.

When the CPU 11 determines that the acquired instruction data indicates instructions to download a configuration file and to configure control parameters based on the configuration file (D02: YES), the CPU 11 performs processes based on the instruction data. For example, in D11 the CPU 11 downloads a configuration file based on the instruction data 37. The instruction data 37 shown in FIG. 20 specifies “Setting.epac” as the configuration file to be downloaded.

In D12 the CPU 11 determines whether the downloaded configuration file is encrypted. For example, “.epac” shown in FIG. 20 is an extension indicating an encrypted file. The CPU 11 may make the determination in D12 based on the extension of the configuration file. When the CPU 11 determines that the configuration file is encrypted (D12: YES), in D13 the CPU 11 determines whether the password included in the instruction data 37 matches the password 26 stored in the memory 12 (see FIG. 11). When the passwords match, the CPU 11 uses this password to decrypt the configuration file.

On the other hand, when the CPU 11 determines that the downloaded configuration file is not encrypted (D12: NO), the CPU 11 does not perform a process based on this configuration file. The CPU 11 uses the password 26 stored in the memory 12 when decrypting a file. When the initial setup process (see FIG. 17) is completed successfully based on the parameter set 834, the password 26 will have been changed from the factory set password 26 to the password 26 specified in the password modification command 836 in the parameter setting command 833 (see FIG. 19), as described above. By including the modified password 26 in the instruction data, the person in charge of managing the MFP 1 can control the MFP 1 to execute a process based on the configuration file. This process can reduce the time and effort of the person in charge of managing the MFP 1 to configure control parameters for the MFP 1.

In D15 the CPU 11 determines whether decryption is completed successfully. When the CPU 11 determines that decryption is completed successfully (D15: YES), in D21 the CPU 11 determines whether the decrypted configuration file is compressed. When the decrypted configuration file is compressed (D21: YES), in D22 the CPU 11 decompresses the configuration file. When the decrypted file is a file compressed with a password, the CPU 11 may use the password 26 to decompress the compressed file. Alternatively, when the CPU 11 determines that the downloaded file is encrypted in D12, the CPU 11 further may determine whether the downloaded file is compressed. When the CPU 11 determines that the downloaded file is encrypted and compressed through the process of D11 and D12, the CPU 11 decrypts and decompresses the downloaded file at a time using the password 26. In D23 the CPU 11 determines whether decompression is completed successfully. When the compressed file is successfully extracted (D23: YES) or when the configuration file is not compressed (D21: NO), in D31 the CPU 11 configures control parameters based on the configuration file. In D31 the CPU 11 may apply the control parameters as setting values for use in controlling the MFP 1. The process of D31 is an example of the configuration process.

However, when the CPU 11 does not obtain instruction data from the management server 6 (D02: NO) or when the instruction data is obtained but the instruction data does not indicate an instruction to configure control parameters based on a downloaded file (D02: NO) or when the downloaded configuration file is not encrypted (D12: NO) or when decryption has been failed due to problems such as the passwords not matching (D15: NO) or when decompression of the compressed file has failed (D23: NO), in D32 the CPU 11 reports an error and does not configure any parameters. Following D31 or D32, the CPU 11 ends the downloading and configuration process and returns to the startup process in FIG. 15.

As described above, the CPU 11 can execute a process based on an unencrypted configuration file when the special setting flag is ON, even though the configuration file is not encrypted (D12: NO). In such cases, the CPU 11 does not report an error.

The MFP 1 can execute processes other than the downloading and configuration process when the execution condition of a registered parameter set is met. The MFP 1 can receive instruction data from a destination accessed based on the URL of a parameter set for which the execution condition is satisfied and can execute a process based on the acquired instruction data. When the instruction data received from the access destination includes an instruction to send status information to the management server 6, the MFP 1 transmits the status information of the MFP 1 to the management server 6.

Returning to the description of the startup process in FIG. 15, when the CPU 11 determines that the execution condition in a parameter set is not satisfied (B41: NO), in B45 the CPU 11 determines whether a user operation has been received through the user interface 13. When the CPU 11 determines that the user operation has been received (B45: YES), in B46 the CPU 11 performs a process based on the received operation.

Following B42 or B46 or when the CPU 11 determines in B45 that a user operation has not been received (B45: NO), the CPU 11 returns to B41 to repeat the determinations in B41. The MFP 1 continues performing the determinations in B41 and B45 while executing various processes based on execution conditions and user operations until the power to the MFP 1 is turned off.

As described above, the MFP 1 of the present embodiment executes the initial setup process (FIG. 17), in a case where the execution condition of the external function parameter set 31 is satisfied (B08 of FIG. 15: YES) after the external function parameter set 31 has been activated (FIG. 13). In the initial setup process, the MFP 1 accesses the settings server 8, receives the password modification command 836 (FIG. 19) from the settings server 8, and updates the password 26 stored in the memory 12 to the password included in the password modification command 836 (C23 of FIG. 17). Thereafter, the MFP 1 uses this new password for configuring control parameters (FIG. 21). In other words, the person in charge of managing the MFP 1 can configure control parameters for the MFP 1 using the new password specified by the password modification command 836 without having to know the password 26 originally set on the MFP 1. This process can be expected to reduce the time and effort of the person in charge of managing the MFP 1 for configuring control parameters.

Further, in the initial setup process executed after activating the external function parameter set 31, the MFP 1 of the present embodiment receives the parameter set 834 included in the parameter setting command 833 (FIG. 19) and registers the parameter set 834 in the external function parameter information 221 (C22 in FIG. 17). Accordingly, the MFP 1 accesses the management server 6 based on the parameter set 834 thereafter. This process can be expected to reduce the time and effort of the person in charge of managing the MFP 1 for registering the parameter set 834.

In the initial setup process following activation of the external function parameter set 31, the MFP 1 of the present embodiment receives the warning non-notification command 832 (FIG. 12A) and thereafter issues no first-type warnings regarding consumables. This process can be expected to reduce the time and effort of the person in charge of managing the MFP 1 to stop some of warning notifications on consumables.

Once the initial setup process is performed successfully after the external function parameter set 31 is activated, the MFP 1 of the present embodiment either disables or changes the display mode of the icon 181 displayed on the home screen 180 (FIG. 16C). This process can be expected to reduce the time and effort of the person in charge of managing the MFP 1 for changing the display mode of icons. Moreover, the end user of the MFP 1 can easily recognize that the initial setup process has been completed successfully.

The second embodiment may be modified in various ways.

For example, the external function parameter set 31 in the second embodiment is stored in the memory 12 in an inactive state prior to the MFP 1 being shipped from the factory and is stored in an active (valid or effective) state in the memory 12 through activation (A21 of FIG. 13), but the present invention is not limited to this configuration. For example, the external function parameter set 31 may not be stored in the memory 12 when the MFP 1 is shipped from the factory but may be later obtained from an external device and then stored in the memory 12 in an active (valid or effective) state.

In the second embodiment, the MFP 1 generates the icon 181 (see FIG. 16B) when the external function parameter set 31 is activated (A26 of FIG. 13) to be displayed on the home screen 180, but the MFP 1 may not generate or display the icon 181. Further, the display modes of icons shown in the drawings are merely one example and the present invention is not limited to these display modes. For example, changing the display mode in B13 (FIG. 15) may include changing the shape or color of the icon 181 or applying a visual effect to the icon 181. For example, a blinking or translucent effect may be added, as a visual effect, to the icon 181.

While the configuration command set 802 containing a plurality of commands (FIG. 12A) is prepared on the settings server 8 in the second embodiment, only the password modification commands 836 may be prepared on the settings server 8 as a command for the MFP 1. Further, the execution condition information 314 specifying the execution condition for accessing the settings server 8 is not limited to the example shown in FIG. 14A. For example, the execution condition may be a condition that allows one-time access (not repeated accesses) or may be a condition involving the reception of a user operation. Further, the commands and instruction data shown in the drawings are merely examples and are not limited to the examples in the drawings.

In the second embodiment, the MFP 1 receives the warning non-notification command 832 (FIG. 12A) from the settings server 8 (C11 in FIG. 17) and halts first-type warning notifications regarding consumables. However, the MFP 1 may be configured to reduce the frequency at which warnings are issued based on the depletion levels of consumables. Rather than halting all warning notifications, the MFP 1 may reduce the frequency of warning notifications to once daily, for example.

The pre-activation information 25 may further store other types of configuration parameter sets including the eco mode parameter sets and the parameter sets to enhance the security as well as the configuration parameter set 32 and the hidden function parameter set 33 shown in FIG. 1. In such a case, the MFP 1 displays a plurality of activation icons respectively corresponding to the parameter sets stored in the pre-activation information 25 in the selection screen 60 (FIG. 3B) in addition to the activation icon 61 to receive a selection of a parameter set to be activated.

The activation server 5 may be accessed by multiple MFPs, and the parameter sets contained in the pre-activation information 25 of the MFPs may differ from each other. In this case, in A03 of FIG. 13, the MFP 1 may transmit information to the activation server 5 indicating the parameter sets included in the pre-activation information 25 stored in the memory 12. Based on this information received from the MFP 1, the activation server 5 may return display instruction data 501 to the MFP 1 for displaying a selection screen containing an activation icon for each parameter set on the MFP 1. The MFP 1 may then display the selection screen according to the received display instruction data 501 and may activate a parameter set associated with an activation icon selected through the selection screen.

MFPs having different parameter sets in their pre-activation information 25 may also store different unique URLs as the activation server information 24. In this case, the activation server 5 may transmit display instruction data 501 to the MFP enabling the MFP to display a selection screen containing activation icons associated with the URL used for accessing the activation server 5, i.e., an activation icon corresponding to each parameter set in the pre-activation information 25 of the MFP that accessed the activation server 5 using this URL. The activation server 5 may also be configured to determine, based on the URL used for accessing the activation server 5, which selection screen containing which activation icons are to be displayed on the MFP.

MFPs that do not store pre-activation information 25 may store a different URL as the activation server information 24 from MFPs that do store pre-activation information 25. In this case, the activation server 5 may transmit display instruction data 501 to the MFP based on the URL used for accessing the activation server 5, enabling the MFP to display a selection screen containing no activation icons. Alternatively, an MFP that does not store pre-activation information 25 may transmit information to the activation server 5 indicating that the MFP has no pre-activation information 25. Here too, the activation server 5 may transmit display instruction data 501 to the MFP enabling the MFP to display a selection screen containing no activation icons.

In the above embodiment, the MFP 1 is configured to receive the activation instruction data 502 containing an activation command from a server, such as the activation server 5, via the network 200, but the MFP 1 may receive the activation instruction data 502 from an external device other than a server, provided that the MFP 1 can connect to the external device and that the external device can transmit the activation instruction data 502. For example, the MFP 1 may receive an activation command from a personal computer on which an application program capable of transmitting the activation command is installed. Information identical to the display instruction data 501 and activation instruction data 502 may also be stored on a server other than the activation server 5.

While the destination for transmitting information about an operation on the Web icon 51 (see FIG. 3A) and the destination for transmitting information about an operation on the activation icons 61 and 62 (see FIG. 3B) are both the activation server 5 in the above embodiment, these destinations may be different devices. Further, in the second embodiment the activation icon 61 and activation icon 62 are included in the selection screen 60, the MFP 1 may include these icons in the display of the standby screen 50. For example, the MFP 1 may possess information for displaying the activation icons 61 in advance. The MFP 1 may not receive the display instruction data 501 in this case, and thus steps A03 and A05 of FIG. 13 may be omitted.

In the above embodiment, the external function parameter set 31 is activated by storing the parameters of the external function parameter set 31 in the external function parameter information 221 (see FIG. 11). However, the MFP 1 may associate each parameter set with a flag specifying whether the parameter set is active. The MFP 1 may use parameter sets whose associated flag indicates that the parameter set is activated for control of the MFP 1 while not using parameter sets not associated with a flag indicating the parameter set has been activated for control of the MFP 1.

While the invention has been described in conjunction with various example structures outlined above and illustrated in the figures, various alternatives, modifications, variations, improvements, and substantial equivalents, whether known or that may be presently unforeseen, may become apparent to those having at least ordinary skill in the art. Accordingly, the example embodiment of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and substantial equivalents. Some specific examples of potential alternatives, modifications, or variations in the described invention are described below:

For example, in addition to the MFP 1, the present disclosure is also applicable to other devices provided that the devices have both a printing function and a communication function to enable communications via a network. Examples of such devices include a printer having no image forming function other than the printing function, a copier, or a fax machine.

In any of the flowcharts and sequence charts disclosed in the embodiment, the plurality of processes that make up any of a plurality of steps may be executed in parallel, or the order in which the processes are performed may be modified in any way that does not produce any inconsistencies in the processes.

The processes disclosed in the embodiment may be executed by a single CPU, a plurality of CPUs, an application specific integrated circuit (ASIC) or other hardware, or a combination of these components. Further, the processes disclosed in the embodiment may be achieved through a storage medium that stores the programs used to implement those processes or according to any of various other methods or formats. The term “processor” encompasses both a single processor or a group of multiple processors located either locally or remotely working together or in a distributed fashion to collectively perform the tasks attributed to the “processor” described herein. One or more processors may be referred to as a controller.

Any combination of the technical elements described in the above embodiments and modifications, including device components (i.e., physical parts of the apparatus), processes, and methods, may be employed as appropriate.

Note that the present disclosure includes the phrases “at least one of A and B”, “at least one of A, B and C”, and the like as alternative expressions that mean one or more of A and B, one or more of A, B and C, and the like, respectively. More specifically, the phrase “at least one of A and B” means (A), (B) or (A and B), and the phrase “at least one of A, B and C” means (A), (B), (C), (A and B), (A and C), (B and C) or (A, B and C).

What is claimed is:

1. A printer comprising:
a communication interface;
a memory; and
a controller including one or more processors,
wherein the controller is configured to perform:
an activation process under an activation start condition including: a requirement that a target parameter set including a plurality of target parameters is stored in the memory as an inactive parameter set not available for processing in the printer; a requirement that an activation command is received from an external device via the communication interface; and a requirement that the activation command is a command to activate the target parameter set, the activation process including:
configuring the target parameter set as an active parameter set available for processing in the printer; and
a controlling process under a controlling condition including a requirement that the activation process is completed, the controlling process being based on the target parameter set.

2. The printer according to claim 1,
wherein the external device is a server,
wherein the controller performs the activation process under the activation start condition further including: a requirement that activation instruction data including the activation command is received from the server via the communication interface using a specific function,
wherein the activation process is performed in accordance with the activation command using the specific function, the specific function being a function to receive instruction data via the communication interface and perform an instructed process in accordance with the instruction data, the activation instruction data serving as the instruction data for the specific function and the activation process serving as the instructed process for the specific function.

3. The printer according to claim 2, further comprising:
a user interface,
wherein the controller is configured to further perform:
an accessing process under an access condition including a requirement that a specific operation is received through the user interface, the accessing process including:
accessing the server via the communication interface using address information stored in the memory; and
a display process using the specific function under a condition including: a requirement that the accessing process is completed; and a requirement that display instruction data is received through the communication interface using the specific function, the display instruction data serving as the instruction data for the specific function, the display process being performed in accordance with the display instruction data and serving as the instructed process for the specific function, the display process including:
displaying a selection screen including a plurality of options on the user interface,
wherein the controller performs the activation process under the activation start condition further including: a requirement that the activation instruction data including the activation command is received from the server via the communication interface in response to receiving a selection of one of the plurality of options in the selection screen.

4. The printer according to claim 1,
wherein the plurality of target parameters includes an address parameter indicating an address of a management server,
wherein the controlling process is performed under the controlling condition further including a specific access requirement, the controlling process including:
accessing the management server using the address parameter via the communication interface.

5. The printer according to claim 4,
wherein the plurality of target parameters further includes a condition parameter indicating the specific access requirement,
wherein the controlling process is performed under the controlling condition that includes the specific access requirement indicated in the condition parameter.

6. The printer according to claim 4,
wherein the external device is a server,
wherein the controller performs the activation process under the activation start condition further including: a requirement that activation instruction data including the activation command is received from the server via the communication interface using a specific function,
wherein the activation process is performed in accordance with the activation command using the specific function, the specific function being a function to receive instruction data via the communication interface and perform an instructed process in accordance with the instruction data, the activation instruction data serving as the instruction data for the specific function and the activation process serving as the instructed process for the specific function.

7. The printer according to claim 6,
a user interface,
wherein the controller is configured to further perform:
an accessing process under an access condition including a requirement that a specific operation is received through the user interface, the accessing process including:
accessing the server via the communication interface using address information stored in the memory; and
a display process using the specific function under a condition including: a requirement that the accessing process is completed; and a requirement that display instruction data is received through the communication interface using the specific function, the display instruction data serving as the instruction data for the specific function, the display process being performed in accordance with the display instruction data and serving as the instructed process for the specific function, the display process including:
displaying a selection screen including a plurality of options on the user interface,
wherein the controller performs the activation process under the activation start condition further including: a requirement that the activation instruction data including the activation command is received from the server via the communication interface in response to receiving a selection of one of the plurality of options in the selection screen.

8. The printer according to claim 4,
wherein the configuring in the activation process includes:
storing the target parameter set in a selected block from a plurality of predetermined blocks included in the memory, a parameter set stored in each of the plurality of predetermined blocks being identified as an active parameter set available for processing in the printer,
wherein the controlling process is based on the target parameter set in the selected block.

9. The printer according to claim 8,
wherein the controller performs the activation process under the activation start condition further including a requirement that no parameter matching the address parameter included in the target parameter set is stored in any of the plurality of predetermined blocks,
wherein the controller does not perform the activation process under a condition including a requirement that a parameter matching the address parameter included in the target parameter set is stored in one of the plurality of predetermined blocks.

10. The printer according to claim 8,
wherein the controller performs the activation process under the activation start condition further including a requirement that one or more of the plurality of predetermined blocks are free, the selected block being selected from the one or more of the plurality of predetermined blocks,
wherein the controller does not perform the activation process under a condition including a requirement that none of the plurality of predetermined blocks is free.

11. The printer according to claim 1, further comprising:
a user interface;
wherein the controller is configured to further perform:
a setting screen display process including:
displaying, on the user interface, a setting screen to receive a second target parameter set as an active parameter set available for processing in the printer; and
a second controlling process under a condition including a requirement that the second target parameter set is received through the setting screen, the second controlling process being based on the second target parameter set,
wherein in a case where the setting screen display process is performed under a condition including a requirement that the activation process is completed, the target parameter set is placed in the setting screen in such a manner that the target parameter set can be modified and the target parameter set after modification can be received as an active parameter set available for processing the printer.

12. The printer according to claim 1, further comprising:
a user interface,
wherein the controller is configured to further perform:
an authentication process under an authentication condition including a requirement that a specific operation is received through the user interface, the authentication process including:
receiving authentication information through the user interface; and
determining whether authentication is successful based on the authentication information,
wherein the controller performs the activation process under the activation start condition further including a requirement that the authentication is successful based on the authentication information,
wherein the controller does not perform the activation process under a condition that the authentication fails based on the authentication information.

13. The printer according to claim 12,
wherein the external device is a server,
wherein the controller is configured to further perform:
an accessing process under a condition including a requirement that the specific operation is received through the user interface, the accessing process including:
accessing the server via the communication interface using address information stored in the memory;
a display process using a specific function under a condition including: a requirement that the accessing process is completed; and a requirement that display instruction data is received from the server through the communication interface using the specific function, the specific function being a function to receive instruction data via the communication interface and perform an instructed process in accordance with the instruction data, the display instruction data serving as the instruction data for the specific function, the display process being performed in accordance with the display instruction data and serving as the instructed process for the specific function, the display process including:
displaying a selection screen including a plurality of options on the user interface; and
an activation instruction receiving process using the specific function under a condition including a requirement that the authentication is successful based on the authentication information, the activation instruction receiving process including:
receiving activation instruction data via the communication interface, the activation instruction data including the activation command, the activation instruction data serving as the instruction data for the specific function, the activation process being performed using the specific function and serving as the instructed process for the specific function,
wherein the authentication process is performed under the authentication condition further including a requirement that a specific option is selected from among the plurality of options through the selection screen,
wherein the activation process is not performed under a condition that the authentication fails based on the authentication information.

14. The printer according to claim 1, further comprising:
an electronic component,
wherein the plurality of target parameters includes a power-saving parameter for saving a power consumption of the electronic component,
wherein the controlling process includes:
controlling the electronic component based on the power-saving parameter to save the power consumption of the electronic component.

15. The printer according to claim 14,
wherein the electronic component is a display panel or a printing engine,
wherein the power-saving parameter is a parameter for saving a power consumption of the display panel or the printing engine, or a parameter to perform automatic power-off of the printer.

16. The printer according to claim 1,
wherein the plurality of target parameters includes an enabling parameter to enable a hidden function and a hidden-function parameter for use in the hidden function, the hidden function being disabled at the time of shipment of the printer,
wherein the configuring in the activation process includes:
configuring both the enabling parameter and the hidden-function parameter to be available for processing in the printer in such a manner that the hidden function become enabled and the hidden function can be used based on the hidden-function parameter,
wherein the controlling process includes:
using the hidden function based on the hidden-function parameter.

17. A printer comprising:
a communication interface;
a memory; and
a controller including one or more processors,
wherein the controller is configured to perform:
an accessing process under an access condition including: a requirement that a first parameter set is stored in the memory as an active parameter set available for processing in the printer; and a requirement that the first parameter set includes a first address parameter indicating a first address, the accessing process including:
accessing a first destination specified by the first address via the communication interface; and
a frequency reducing process under a reducing condition including a requirement that the accessing process is completed, the frequency reducing process including:
reducing a warning frequency, the warning frequency being a frequency of execution of a first warning process based on a consumption level regarding a consumable.

18. The printer according to claim 17,
wherein the controller is configured to further perform:
a password-update process under an update condition including: a requirement that a first password is stored in the memory as a current password; a requirement that the accessing process is completed; and a requirement that a second password is received from the first destination through the communication interface, the password-update process including:
storing the second password in the memory as the current password; and
a setting process under a setting condition including: a requirement that a control parameter is stored in the memory; and a requirement that the password-update process is completed; and a requirement that a setting instruction is issued, the setting instruction being an instruction to set the control parameter as an available setting value of the printer, the setting process including:
setting, using the second password as the current password, the control parameter as the available setting value of the printer.

19. The printer according to claim 17,
wherein the controller is configured to further perform:
a storing process under a storing condition including: a requirement that the accessing process is completed; a requirement that a second parameter set is received from the first destination via the communication interface; and a requirement that the second parameter set includes a parameter indicating a second address and a parameter indicating an access schedule, the storing process including:
storing the second parameter set in the memory as an active parameter set available for processing in the printer; and
a second accessing process under a second access condition including a requirement that the storing process is completed, the second accessing process including:
accessing a second destination specified by the second address based on the access schedule.

20. A printer comprising:
a communication interface;
a user interface;
a memory; and
a controller including one or more processors,
wherein the controller is configured to perform:
an accessing process under an access condition including: a requirement that a target parameter set is stored in the memory as an active parameter set available for processing in the printer; and a requirement that the target parameter set includes an address parameter indicating an address, the accessing process including:
accessing a first destination specified by the address via the communication interface; and
either a first process or a second process,
wherein the first process includes:
a first display process under a condition including: a requirement that the target parameter set is stored in the memory as the active parameter set available for processing in the printer; and a requirement that the accessing process is not started, the first display process including:
displaying a standby screen in which a display object is placed in a first mode on the user interface, the display object being for issuing an instruction to access the first destination specified by the address; and
a first switching process under a first switching condition including a requirement that the accessing process is completed, the first switching process including:
switching the display object from the first mode to a second mode different from the first mode,
wherein the second process includes:
a second display process under a condition including: a requirement that the target parameter set is stored in the memory as the active parameter set available for processing in the printer; and a requirement that the accessing process is not started, the second display process including:
displaying the standby screen in which the display object is placed in an enabled state where an access instruction to access the first destination specified by the address can be issued when the display object is operated; and
a second switching process under a second switching condition including a requirement that the accessing process is completed, the second switching process including:
switching the display object from the enabled state to one of: a first disabled state where the display object cannot be operated; or a second disabled state where the access instruction cannot be issued based on an operation of the display object.
